(19) United States
(12) Patent Application Publication
(10) Pub. No.: US 2024/0192068 A1
(43) Pub. Date: Jun. 13, 2024

(54) TORQUE MEASUREMENT DEVICE AND SYSTEM

(71) Applicant: LORD Corporation, Cary, NC (US)

(72) Inventors: Daniel Kakaley, Cary, NC (US); Russell Altieri, Holly Springs, NC (US); Mikhail Gordleev, Pittsboro, NC (US); Warren Brannan, Sanford, NC (US); John Sheppard, New Hill, NC (US); Victor Zaccardo, Durham, NC (US); Joseph Pawlowski, Erie, PA (US); Edward Hudson, Solon, OH (US)

(73) Assignee: LORD Corporation, Cary, NC (US)

(21) Appl. No.: 18/286,899

(22) PCT Filed: Apr. 14, 2022
(86) PCT No.: PCT/US2022/024877

§ 371 Date: Oct. 13, 2023

Related U.S. Application Data
(60) Provisional application No. 63/175,130, filed on Apr. 15, 2021.
(60) Provisional application No. 63/256,236, filed on Oct. 15, 2021.

(51) Int. Cl. G01L 3/10

(52) U.S. Cl. CPC G01L 3/104

(57) ABSTRACT

A shaft assembly for a torque measurement system having a shaft that rotates is provided. The shaft assembly includes a cylinder fitted on to a shaft having flexible area, where the targets are formed after the cylinder is secured to the shaft and/or a cylinder mounting surface.

### CROSS-REFERENCE TO RELATED APPLICATIONS

The present application claims the benefit of U.S. Provisional Patent Application Ser. No. 63/175,130, filed on Apr. 15, 2021, and entitled “TORQUE MEASUREMENT DEVICE AND SYSTEM,” and U.S. Provisional Patent Application Ser. No. 63/256,236, filed on Oct. 15, 2021, and entitled “TORQUE MEASUREMENT DEVICE AND SYSTEM,” the disclosures of which are incorporated herein by reference in their entirety.

### FIELD OF INVENTION/BACKGROUND

The subject matter disclosed herein relates to devices and systems for measuring twist between two locations on a shaft that rotates.

### BACKGROUND

For rotating shafts, such as those found in drivetrains, knowing the torque transmitted by the shaft or driveshaft, and the amount of twist in the shaft or driveshaft is important to numerous industries. An example is a jet engine shaft rotating between a transmission and the various turbine blades. Knowing the torque and twist of the shaft allows the jet engine controller to enable the jet engine to operate at its peak performance and while ensuring the turbine blades remain within the operational parameters and safety of flight limitations. This same concept applies to any situation where there is a torque input to the shaft and the shaft may undergo a twist.

The measurement of the torque and twist is sometimes accomplished using variable reluctance (VR) sensors along with associated electronics. The VR sensors measure changes to the timing pulses produced by the passage of the rotating target. The rotating target is created and secured to the rotating shaft or an element within the rotating shaft. The VR sensors and the targets are part of the torque measurement system.

Integrating metal targets into a shaft or drivetrain for a torque measurement system is difficult and introduces errors into the separation of the targets as well as introducing stresses and strains impacting measurements. In addition, it is difficult to form or machine the targets in a stand-alone configuration. Individually, making the components separately has problems with the inherent material property of the targets, the tolerances on the machined targets, and warping of the shaft or the shaft assembly subsequent heat treating. When the part is made of a single piece, it is difficult to machine the critical load bearing components, which require stringent tolerances. These difficulties create accuracy issues and production issues for torque monitoring systems.

Although, there are difficulties with a single piece stand-alone shaft, the added part complexity of the two-piece solution may still be a desired solution. In such a case, the difficulties of creating the single piece stand-alone shaft limit the twist of torque through the shaft.

What is needed is a solution that overcomes the limitations of the single piece stand-alone shaft in either a multi-piece solution or in a single piece solution with improved twist of the torque through the shaft.

### SUMMARY OF THE INVENTION

In one aspect, a shaft assembly for a torque measurement system having a shaft that rotates is provided. The shaft assembly comprises a shaft having a flexible area, a cylinder, and a plurality of targets. The flexible area capable of twisting when an external load is applied to the shaft. The shaft has a first end, a second end, an outer surface, and a cylinder mounting surface. The cylinder is capable of being secured to the cylinder mounting surface, the cylinder having an inner. The plurality of targets are integrally formed in or through the cylinder after the cylinder is secured to the shaft and/or the cylinder mounting surface, the plurality of targets having a pattern.

In another aspect, a method of making a shaft assembly for a torque measurement system having a shaft that rotates is provided. The method comprises positioning a cylinder on the shaft and/or a cylinder mounting surface of the shaft, the shaft having a flexible area, the cylinder positioned radially outward from the flexible area; securing the cylinder to the shaft and/or the cylinder mounting surface; and machining a plurality of targets into or through the cylinder after the cylinder is secured to the shaft and/or cylinder mounting surface, the targets having a pattern, wherein each target is able to move relative to the other targets.

In still another aspect a shaft assembly for a torque measurement system having a shaft that rotates is provided. The shaft assembly comprises a shaft, a plurality of machined spokes, and a plurality of targets. The shaft has at least one flexible area, the flexible area capable of twisting when an external load is applied to the shaft, the shaft having a first end, a second end, and an outer surface. The plurality of machined spokes provide a first flexible area of the at least one flexible areas, wherein the machined spokes are flexible with a torsion. The plurality of targets are integrally formed in or through the cylinder after the cylinder is secured to the shaft and/or the cylinder mounting surface, the plurality of targets having a pattern.

### BRIEF DESCRIPTION OF THE DRAWINGS

FIG. 1 illustrates a perspective view of the shaft assembly with the flexible area and cylinder of the disclosed invention positioned side-by-side.

FIG. 2A illustrates an exploded perspective view of the shaft assembly with the flexible area and cylinder lined up for assembly.

FIG. 2B illustrates an embodiment of the shaft lacking outwardly extending cylinder mounting surfaces.

FIG. 3A illustrates a perspective view of the cylinder positioned on the shaft radially outward from the flexible area.

FIG. 3B illustrates a perspective view of the cylinder positioned on the shaft radially outward from the flexible area where the cylinder carries inwardly projecting flanges with cylinder mounting surfaces.

FIG. 4A illustrates a section view of the cylinder positioned radially outward from the flexible area as found in FIGS. 2A and 3A.

FIG. 4B illustrates a section view of the cylinder carrying an inwardly projecting flange supporting cylinder mounting surfaces in contact with the shaft. The cylinder positioned radially outward from the flexible area as found in FIGS. 2B and 3B.

FIG. 5 illustrates a perspective view of the targets formed in the cylinder which is positioned radially outward from the flexible area.

FIG. 6 illustrates a detail view of representative targets and pattern from FIG. 5.

FIG. 7 illustrates a section view of the shaft assembly taken along line 7-7 of FIG. 5.

FIG. 8 illustrates a side view of the shaft assembly.

FIG. 9 illustrates a section view of the shaft assembly taken along line 9-9 of FIG. 8.

FIG. 10 illustrates a side view of the shaft assembly in an inverted position.

FIG. 11 illustrates a perspective view of the cylinder having a first and a second cylinder element.

FIGS. 12A and 12B illustrate a perspective view of an alternative embodiment of shaft and target assembly formed from a single element.

FIG. 12C illustrates a first end view of the shaft and target assembly illustrated in FIG. 12A.

FIG. 12D illustrates a second end view of the shaft and target assembly illustrated in FIG. 12A.

FIG. 12D illustrates a perspective view of the shaft and target assembly illustrated in FIG. 12A from the first end.

FIG. 12E illustrates a side view of the shaft and target assembly illustrated in FIGS. 12A-12D.

FIG. 12F illustrates a section view taken along the line 12F-12F in FIG. 12E.

FIGS. 13A and 13B illustrate a perspective view of another alternative embodiment of shaft and target assembly formed from a single element.

FIG. 13C illustrates a first end view of the shaft and target assembly illustrated in FIG. 13A.

FIG. 13D illustrates a second end view of the shaft and target assembly illustrated in FIG. 13A.

FIG. 13D illustrates a perspective view of the shaft and target assembly illustrated in FIG. 13A from the first end.

FIG. 13E illustrates a side view of the shaft and target assembly illustrated in FIGS. 13A-13D.

FIG. 13F illustrates a section view taken along the line 13F-13F in FIG. 13E.

FIGS. 14A-14C are the section view of FIGS. 9, 12F, and 13F illustrated side-by-side.

FIG. 15 depicts an alternative embodiment of the shaft in an exploded view, wherein the shaft has multiple flexible areas.

FIG. 16 depicts the assembled version of the embodiment of FIG. 15 after welding of the cylinder to the shaft and machining of the cylinder.

FIG. 17 illustrates an exemplary configuration of the sensor arrangement suitable for use with the torque measurement system.

FIGS. 18 and 19 depict alternative embodiments of the shaft and targets wherein individual targets are carried by the shaft.

### DETAILED DESCRIPTION

The drawings included with this application illustrate certain aspects of the embodiments described herein. However, the drawings should not be viewed as exclusive embodiments. The subject matter disclosed is capable of considerable modifications, alterations, combinations, and equivalents in form and function, as will occur to those skilled in the art with the benefit of this disclosure.

The present disclosure may be understood more readily by reference to these detailed descriptions. For simplicity and clarity of illustration, where appropriate, reference numerals may be repeated among the different figures to indicate corresponding or analogous elements. The following description is not to be considered as limiting the scope of the embodiments described herein. The drawings are not necessarily to scale and the proportions of certain parts may have been exaggerated to better illustrate details and features of the present disclosure. Also, the phraseology and terminology employed herein is for the purpose of description and should not be regarded as limiting except where indicated as such.

Throughout this disclosure, the terms “about”, “approximate”, and variations thereof, are used to indicate that a value includes the inherent variation or error for the device, system, or measuring method being employed as recognized by those skilled in the art.

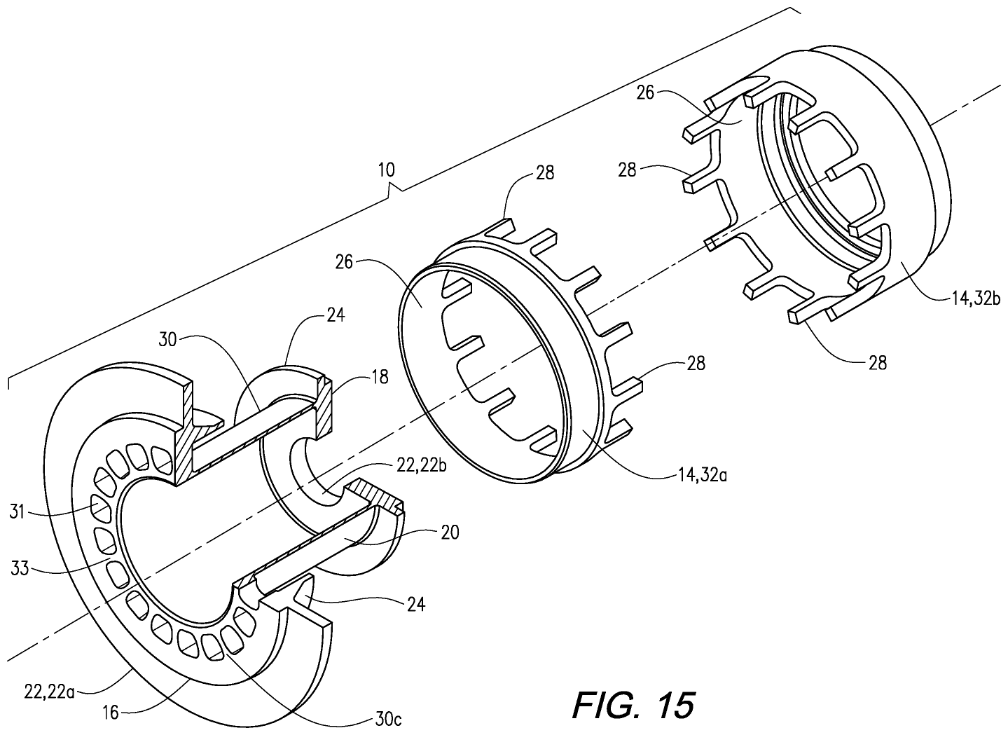

Torque measurement systems commonly include rotating shafts which transmit torque. The following disclosure describes an improved shaft assembly for a torque measurement system. The shaft may be a drivetrain. The shaft transmits torque from one end of the shaft to the other end of the shaft. The shaft has at least one flexible area. The at least one flexible area may be located as several locations as discussed below. The location of the flexible area is selected to permit twisting of the flexible area when torque is transmitted through the shaft. Thus, to provide the desired functionality, a flexible area must reside in the path of torque transmission. For example, area 30c of FIG. 15 resides in the path of torque transmission and will function as a flexible area 30c. When provided initially as two distinct parts, each part of the cylinder may initially include “rough” targets, i.e. targets that have not been machined to their final configuration. Alternatively, the cylinder may be provided initially as a single unitary component when secured to the shaft. Following securement of the unitary cylinder to the shaft, final targets are machined into or through the cylinder thereby dividing the cylinder into two distinct components. Thus, the inventive solutions allow for the critical dimensions of the cylinder, i.e. the targets, to be machined using standard machining methods with precise measurements.

The unexpected result provided by the various disclosed embodiments results from the final machining of the targets following assembly of the cylinder as a unitary cylinder or two part cylinder to the shaft. Subsequent final machining of the targets enhances the ability to accurately measure rotational (degrees) twist and linear shifting of the targets relative to one another. Specifically, the configuration resulting from first attaching the unitary or two part cylinder to the shaft followed by final machining of the targets imparts significantly greater accuracy of shape to the targets and provides the desired accuracy of the distance between adjacent targets. As a result, when torque is applied to the torque measurement system, the torque measurement system can detect twist starting at rotational change of 3 millidegrees for a 4″ diameter shaft 12 which equates to a linear change in distance between adjacent targets of 0.00015 inch. This degree of accuracy results from machining all teeth following assembly of unitary or two part cylinder 14 to shaft 12. The machining of all teeth in a single step using a single machining device provides extreme parallelism between targets. In a typical configuration using a 4″ diameter shaft, at maximum torque, the rotational change will be about 0.5 degrees of twist and the linear change will be 0.0175 inch.

The securing of the either the two part or unitary cylinder to the shaft may be accomplished using known methods, such as welding, match drilling followed by riveting and other suitable methods known in the art. Machining of the targets following securement of the cylinder to the shaft provides the required precision of each target relative to the adjacent targets as the machining tolerance of the targets will correspond to that of the accuracy of a single machining tool. This approach improves accuracy by between at least a factor of two (2) and a factor of ten (10) over currently used approaches. In a non-limiting example, the accuracy is increased between 0.001 inch and 0.0001 inch. Thus, while the required distance of gap 38 will vary from application to application the preferred tolerance for gap 38 will be 0.0001 inch to 0.0002 inch from the specified gap distance; however, a tolerance of up to 0.00015 will be acceptable. This enhanced tolerance in machining gap 38 between adjacent targets 28 enables measurement of torque using only 0.5 degrees of full torque twist and permits initial detection of a change in torque starting at 3 millidegrees of twist.

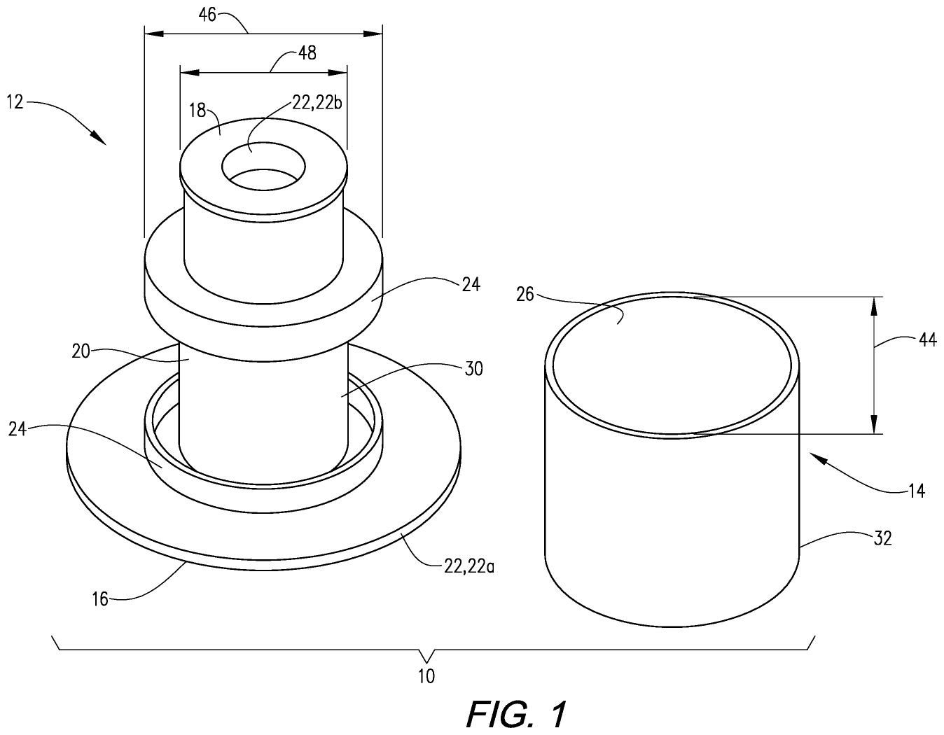

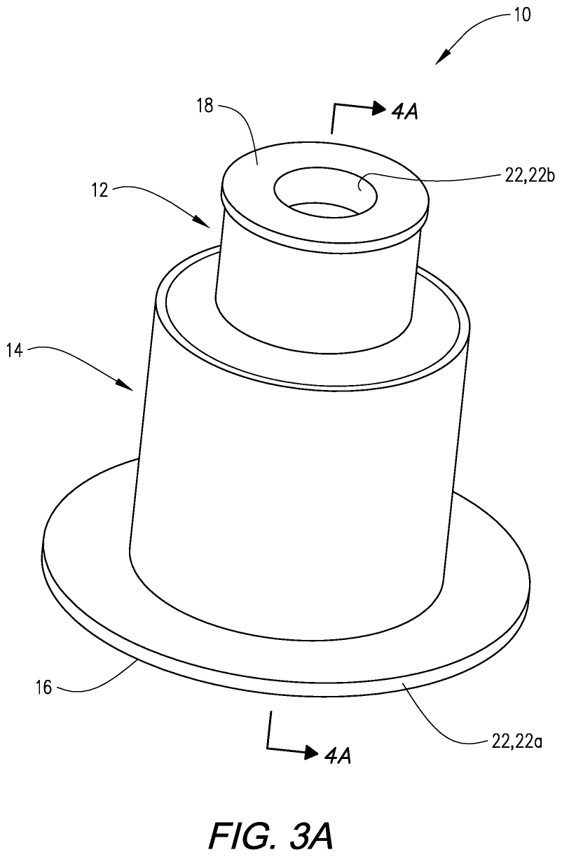

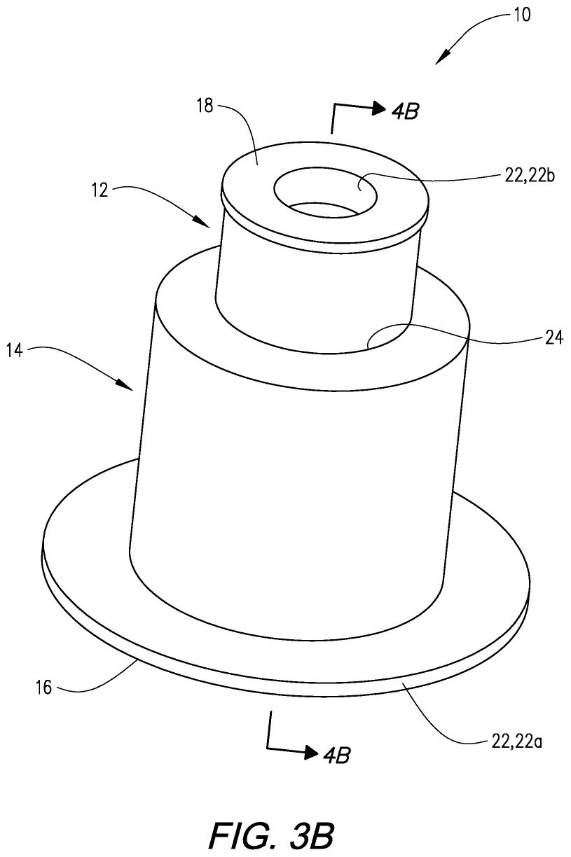

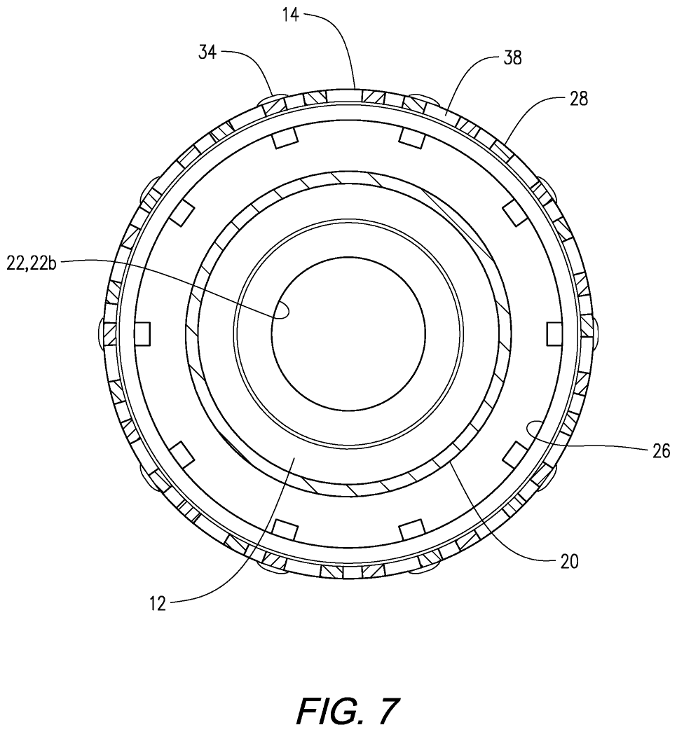

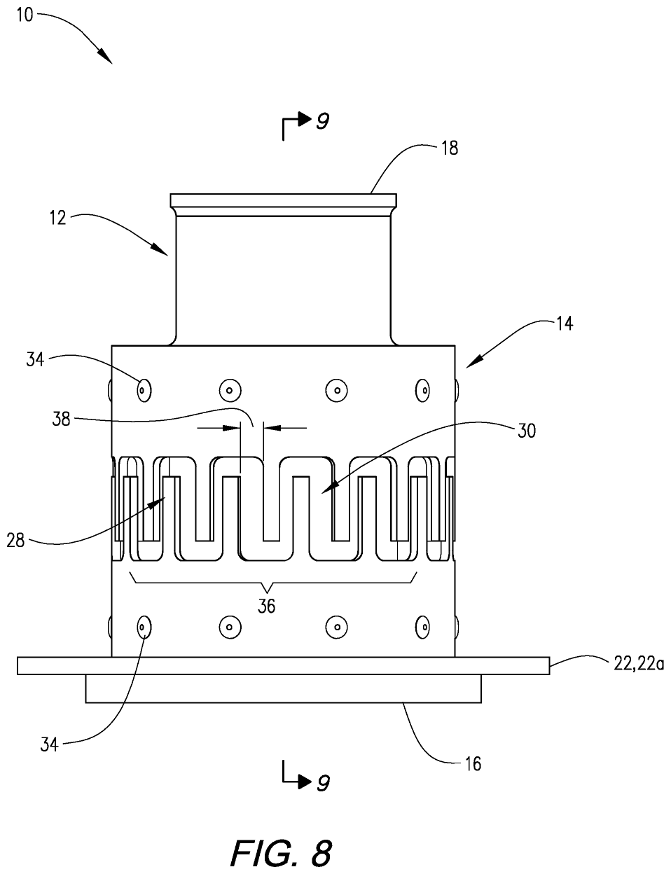

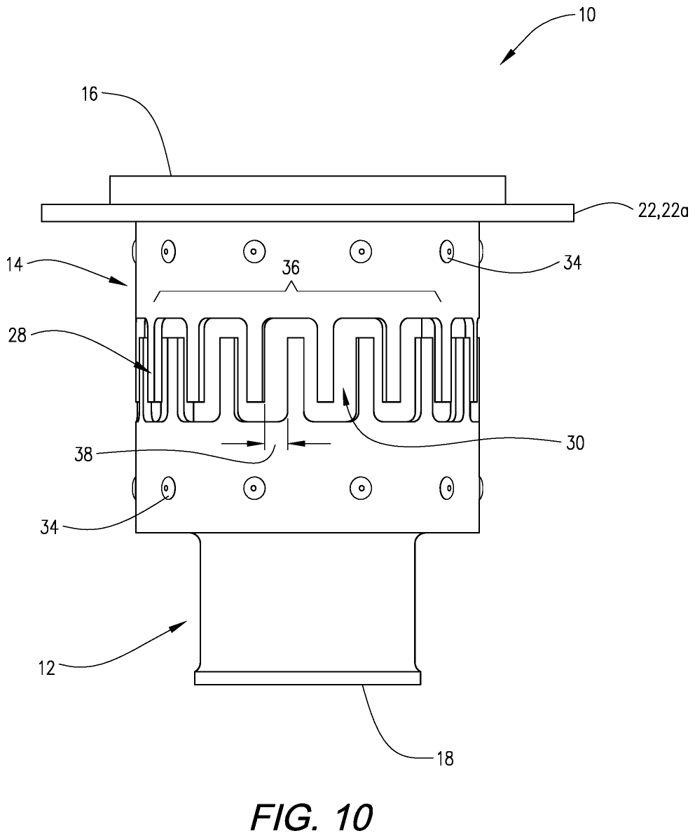

FIGS. 1-10 illustrate one embodiment of a shaft assembly 10 of a torque measurement system (not shown), which is generally designated as shaft assembly 10. The torque measurement system is capable of measuring torque by monitoring the twisting on a shaft 12 as torque input is applied to shaft 12 during rotation of shaft 12. A portion of the shaft 12 includes a flexible area 30. A cylinder 14 is secured to shaft 12 radially outward from flexible area 30. The shaft 12, flexible area 30, and cylinder 14, as described herein, form the shaft assembly 10. Unless otherwise stated, for the purposes of the remainder of this disclosure, cylinder 14 refers generically to both a single unitary cylinder and to a cylinder initially provided as a two component cylinder. Further, following machining a unitary cylinder 14 will be modified to a two part cylinder 14 having components 32a and 32b.

In addition to flexible area 30, shaft 12 has a first end 16, a second end 18 and an outer surface 20. The first end 16 and second end 18 are positioned between a first component (not shown) and a second component (not shown) of shaft 12.

Referring to FIGS. 1-3, 5 and 6-11, shaft 12 may further have an attachment element 22 used to connect the shaft assembly 10 between the first and second component, where one of the components is a torque input device (not shown) such as a transmission (not shown). The attachment element 22a may be positioned on the first end 16 and another attachment element 22b positioned on the second end 18. Or there may only be a single attachment element 22. In the non-limiting illustrations of FIGS. 1-3, 5 and 6-11, attachment element 22a is an attachment flange 22a and attachment element 22b is capable of receiving an element that is transmitting torque, i.e. in most configurations, element 22b corresponds to the torque input side of shaft assembly 10. Attachment element 22 may be configured as attachment flanges 22 positioned on first and second ends 18, 20.

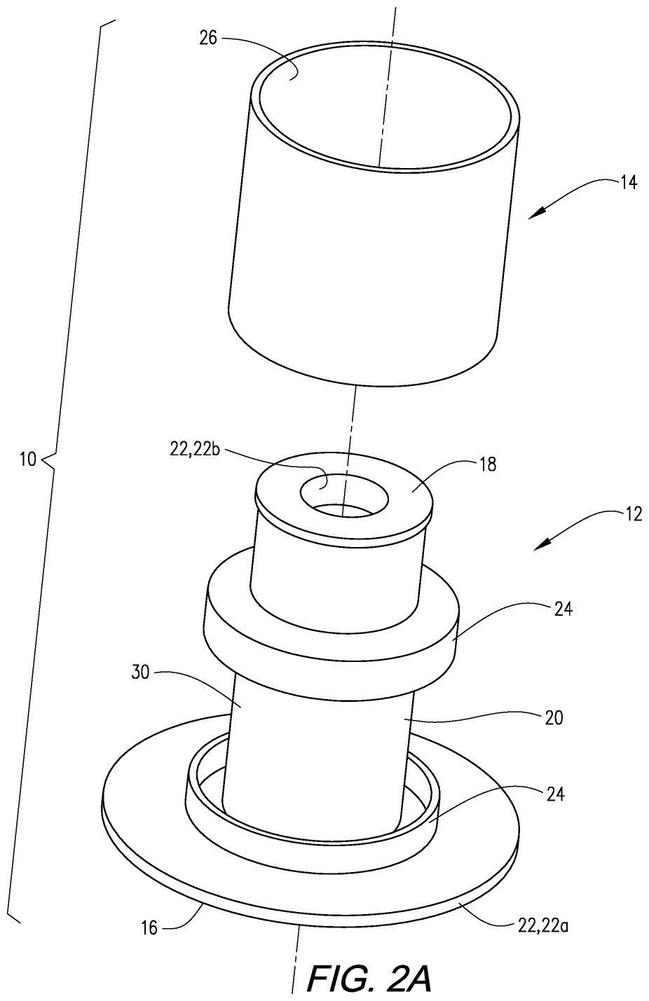

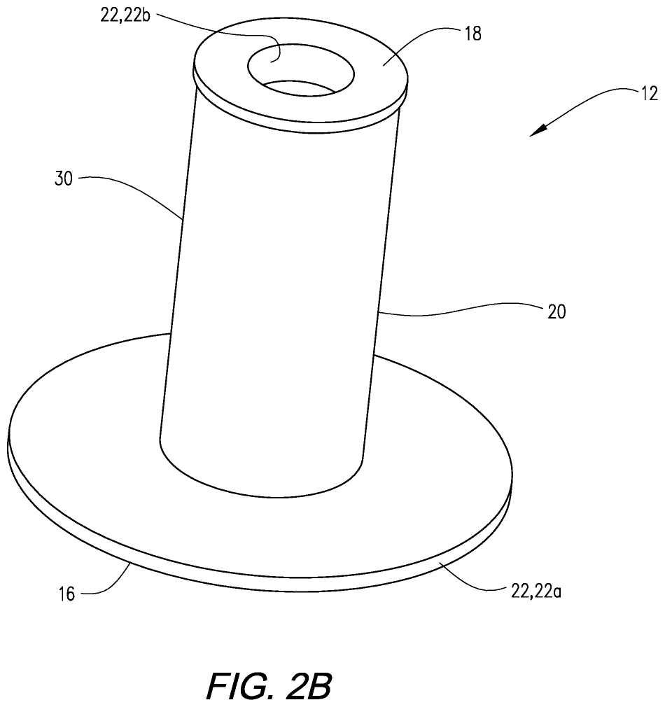

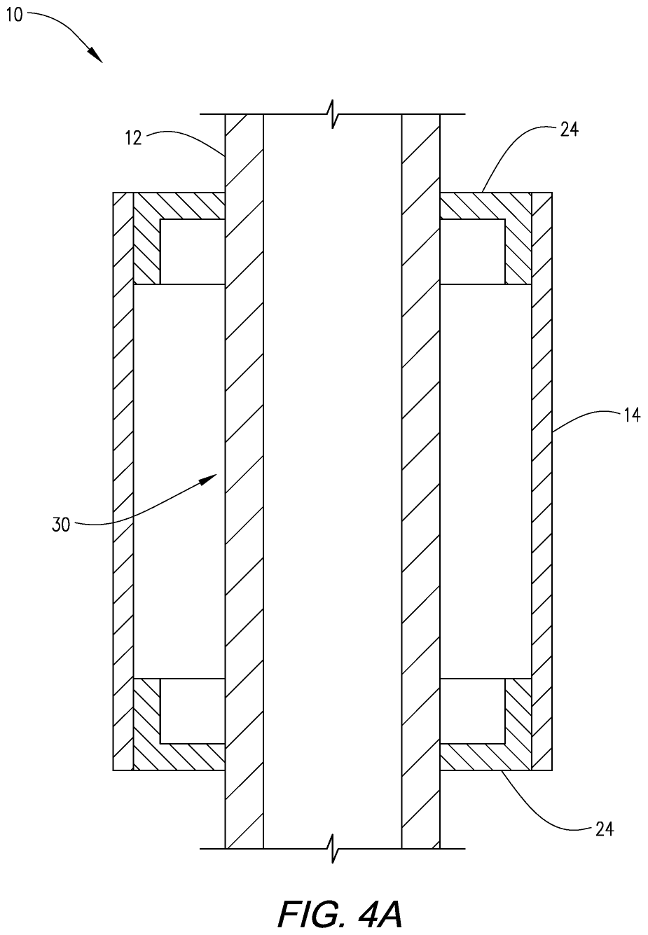

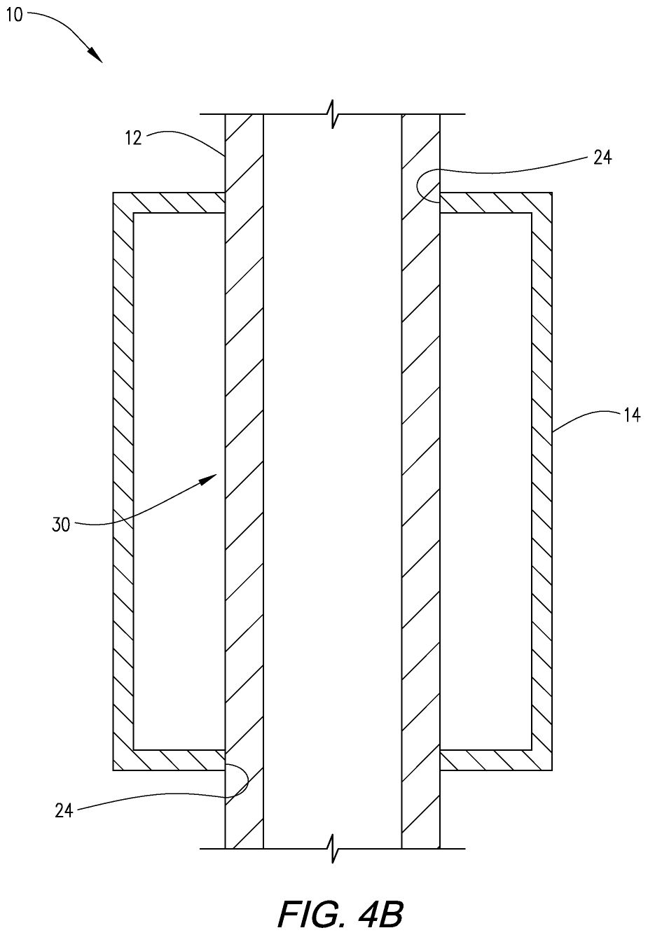

In FIGS. 1, 2A, 3A and 4A, shaft 12 is also illustrated as having an optional cylinder mounting surface 24 for securing cylinder 14 to shaft 12. Cylinder mounting surface 24 is illustrated as outwardly protruding from the outer surface 20 of shaft 12 proximate flexible area 30. However, cylinder mounting surface 24 may be positioned anywhere that allows cylinder 14 to be positioned radially outward from flexible area 30. FIGS. 2B, 3B and 4B depict an alternative to cylinder mounting surface 24 carried by shaft 12. In this embodiment, shaft 12 has a smooth continuous area and cylinder 14 fits over shaft 12 with cylinder mounting surfaces 25 carried by cylinder 14 in contact with the outer surface of shaft 12. As depicted in these FIGS., cylinder 14 carries at least one inwardly projecting flange 25 which substitutes as cylinder mounting surface. As depicted in FIG. 4B, cylinder 14 has two inwardly projecting flanges 25 positioned such that following attachment of cylinder to shaft 12 the flexible area 30 of shaft 12 will be located between inwardly projecting flanges 25. In this embodiment, flange 25 defines an interior diameter which corresponds to the outside diameter of shaft 12. Thus, flange 25 provides the point for securing cylinder 14 to shaft 12. In another alternative embodiment, mounting of cylinder 14 to shaft 12 may be as a combination of cylinder mounting surfaces 24 and 25. In other words, shaft 12 may carry one cylinder mounting surface 24 and cylinder 14 may carry an inwardly projecting flange 25. So long as both mounting locations are located outside of flexible area 30, the configuration will perform satisfactorily.

When the cylinder mounting surface 24 protrudes from the outer surface 20 of shaft 12, there is at least one cylinder mounting surface 24. For non-limiting illustration purposes only, there are two cylinder mounting surfaces 24 associated with shaft 12. In most configurations, cylinder mounting surfaces 24 or flanges 25 are spaced apart with flexible area 30 located between the spaced apart cylinder mounting surfaces 24 or flanges 25. Typically, at least one cylinder mounting surface 24 will be located proximate to either end 16 or 18 of shaft 12. As depicted in FIG. 2, one cylinder mounting surface may be offset or set back from either end 16 or 18. FIGS. 1-5, 7, and 9-11 depict various configurations of shaft assembly 10. As depicted, cylinder mounting surface(s) 24 may only slightly protrude from outer surface 20 of shaft 12 or flanges 25 may provide on slight offset from shaft 12. The primary requirement being provision of a radial distance between flexible area 30 and cylinder 14 sufficient to allow movement of the plurality of targets 28. As illustrated, each cylinder mounting surface 24 is integrally formed with shaft 12; however, each cylinder mounting surface 24 may also be welded, bonded, or otherwise secured to outer surface 20 of shaft 12. As illustrated in FIGS. 1-5, 7, and 9-11, the outer diameter 48 of flexible area 30 that is smaller than the outer diameter 46 of cylinder mounting surfaces 24. In most embodiments having separated cylinder mounting surfaces 24, the outer diameter of each cylinder mounting surface 24 will be identical. Flexible area 30 is axial with and positioned radially inward from cylinder 14 and the plurality of targets 28.

Cylinder 14 has an inner surface 26. The cylinder 14 is capable of being positioned on and around at least a portion of outer surface 20 of flexible area 30 of shaft 12 with inner surface 26 facing flexible area 30. Thus, cylinder 14 and flexible area 30 rotate with the shaft 12.

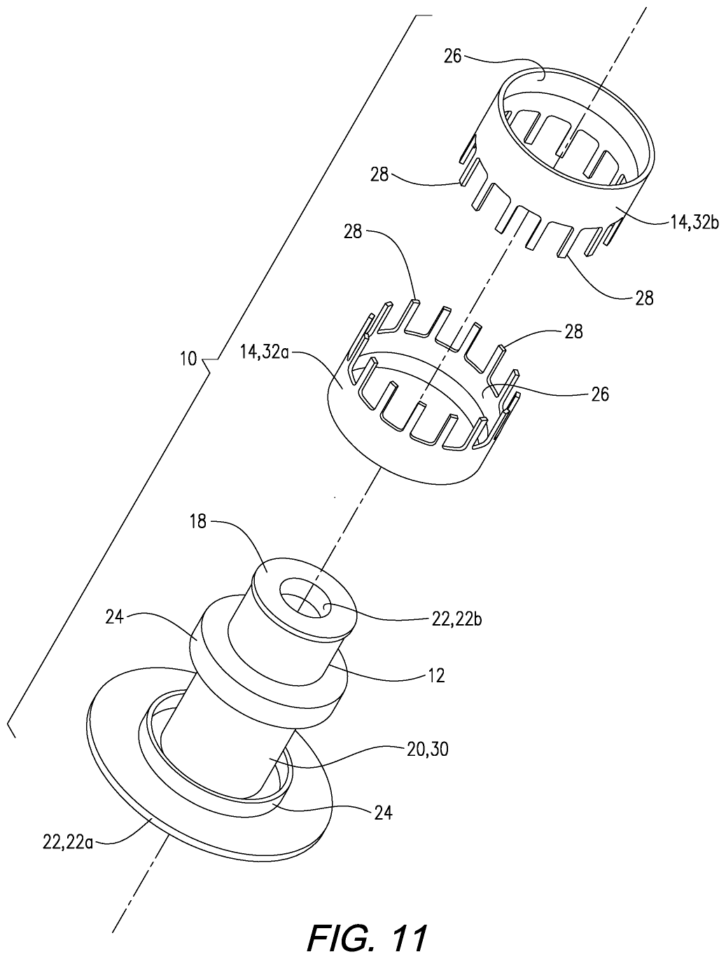

FIGS. 1-4 depict cylinder 14 as a unitary cylinder 32. Unitary cylinder 32 is a contiguous cylinder. As illustrated in FIGS. 1-4, the plurality of targets 28 have not yet been formed on the unitary cylinder 32. FIG. 11 depicts a two component cylinder 14 in the arrangement of a first cylinder element 32a and a second cylinder element 32b. As illustrated in FIG. 11, the first and second cylinder elements 32a, 32b have rough pre-formed targets which will subsequently be finally machined to create the plurality of targets 28. In FIG. 11 the first and second cylinder elements 32a, 32b are illustrated in an exploded view and are shown prior to being positioned on shaft 12. When first and second cylinder elements 32a, 32b are used, they are positioned on and secured to cylinder mounting surface 24 of shaft 12. As noted above, points for securing cylinder 14 to shaft 12 may be carried by shaft 12 or by cylinder 14. Following securement of first and second cylinder elements 32a, 32b to shaft 12, final machining of the plurality of targets takes place to provide final targets 28. Final machining of targets 28 resolves any material property, cylinder positioning, or machine setup errors in shaft 12 and cylinder 14 thereby providing the desired tolerances necessary to achieve the above described unexpected results.

Whether cylinder 14 is a unitary cylinder 32 or comprised of the first and second cylinder elements 32a, 32b, cylinder 14 is secured to the shaft 12 by any of many known techniques. Non-limiting examples of suitable techniques for securing cylinder 14 to shaft 12 include welding, match drilling and blind riveting using rivets 34, drill and tapping to permit use of screws (not shown) bonding techniques, press or friction fitting and a slot/key configuration.

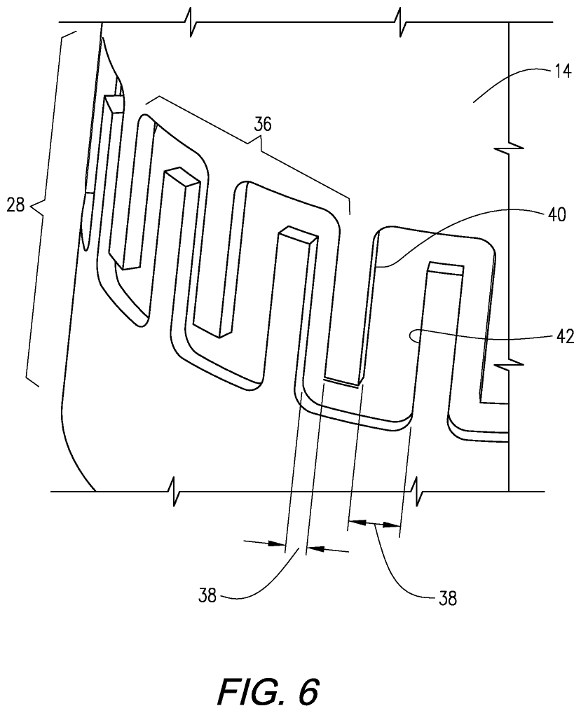

Once cylinder 14 is secured to shaft 12, the plurality of targets 28 are integrally formed in or through the cylinder 14. When using a single cylinder 14 as depicted in FIGS. 1-5, the formation of targets 28 effectively splits cylinder 14 into two halves 32a, 32b. The resulting plurality of targets 28 form a pattern 36 defining the separation point of cylinder 14. As depicted in FIGS. 6-8, 10 and 12E, adjacent targets are separated from each other by a gap 38. Each target has a first side 40 and a second side 42. Gap 38 is positioned between the first side 40 of a target and a second side 42 of an adjacent target 28 with adjacent targets 28 carried by opposing halves of cylinder 14.

When cylinder 14 is in the configuration first and second cylinder elements 32a, 32b, the plurality of targets 28 may be partially pre-formed prior to securing first and second cylinder elements 32a, 32b to shaft 12. If the plurality of targets 28 are pre-formed, additional machining provides for a precise and consistent pattern 36 necessary to establish distance 38. If targets 28 were not preformed, then machining of first and second cylinder elements 32a, 32b will provided the final desired configuration and tolerances of targets 28 including gap 38. The plurality of targets 28 may be independent of each other, or the plurality of targets 28 may be connected through cylinder 14.

Machining of targets 28 provides pattern 36. Pattern 36 may position the plurality of targets 28 in any number of shapes and orientations with the only limiting factor being a consistent distance for gap 38. In a non-limiting example, the plurality of targets 28 are uniformly parallel relative to each other, or the plurality of targets 28 are uniformly slanted relative to each other, or the plurality of targets 28 are a combination of parallel and slanted targets, where the orientation of each target is relative to the other target. Additionally, the non-limiting example of the pattern 36 allows for each individual target of the plurality of targets 28 to have a unique orientation relative to at least each target nearest to each other. In still another non-limiting example of the pattern 36, the plurality of targets 28 may have alternating patterns 36.

After shaft 12 and cylinder 14 are secured together and the plurality of targets 28 are machined, the shaft 12 and both halves of cylinder 14 all rotate together in response to torque input. During rotation, each target of the plurality of targets 28 is able to move relative to every other target when the shaft 12 is being rotated and at least one flexible area 30 is being subjected to a twist. Stated another way, each target is able to move relative to the first end 16 of shaft 12, the second end 18 of shaft 12, and/or relative to each other target.

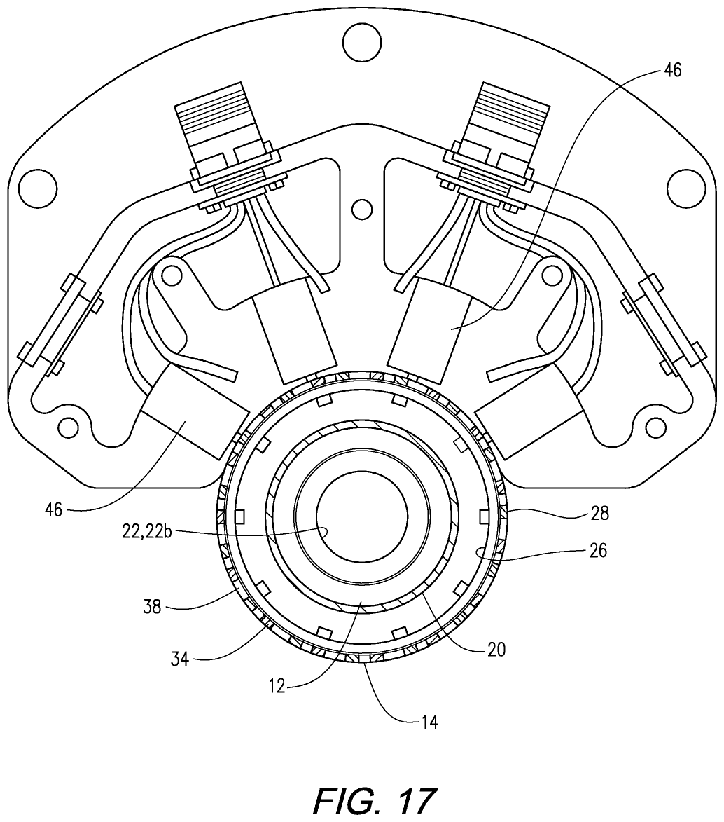

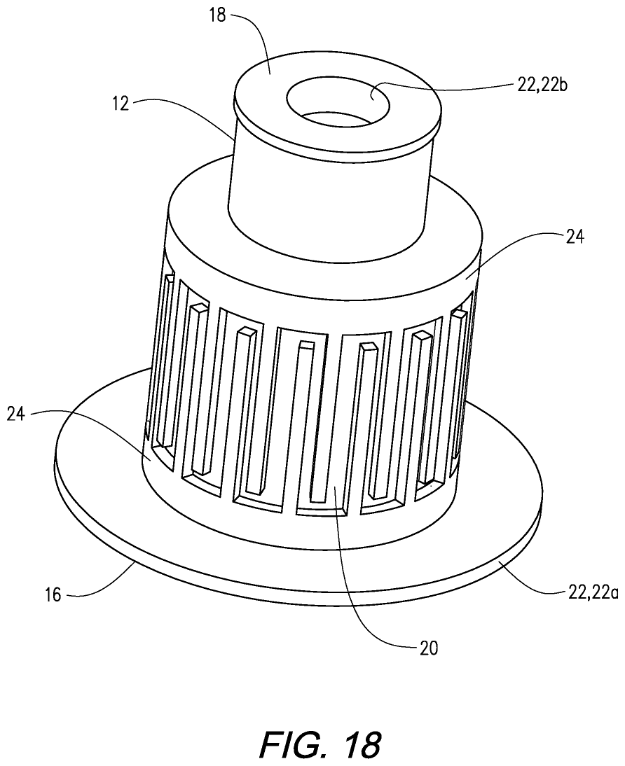

In the embodiment of FIGS. 1-10, 15-16 and 18, when shaft 12 is subjected to torque, flexible area 30 twists. The plurality of targets 28 move relative to one another in response to the twist and the movement is capable of being measured by at least one sensor 46. Specifically, as one target 28 moves relative to another target 28, distance 38 between the two targets 28 will change. Sensor 46 provides the ability to monitor the change in distance 38. FIG. 17 depicts one of many suitable configurations for sensor(s) 46 positioned to monitor movement of targets 28. Any sensor capable of measuring movement of targets 28 will suffice. However, a variable reluctance sensor will be particularly suited for this application. The amount of twist in flexible area 30 is small. Therefore, the machining tolerance precision of the plurality of targets 28 must be sufficient to permit sensor monitoring of targets 28 to within at least 3 millidegrees of accuracy. In other words, the resulting final machined targets 28 are remarkably consistent from one target 28 to the next target 28 such that distance 38 is also remarkably consistent around the circumference of shaft 12. The enhanced consistency of distance 38 provides the resulting 3 millidegrees of accuracy which in turn provides the ability to more accurately measure torque applied to shaft 12.

Shaft 12 and flexible area 30 must be durable to withstand cyclical flexing over the lifetime of shaft 12. Shaft 12 and cylinder 14 may have similar material properties. Alternatively, shaft 12 and cylinder 14 may have dissimilar material properties.

Preparation of the above described shaft assembly 10 relies upon a novel method. According to the novel method, cylinder 14 is positioned on and secured to shaft 12. As noted above securement points between cylinder 14 and shaft 12 may be in the form of outwardly projecting flanges with cylinder mounting surfaces 24 carried by shaft 12 or inwardly projecting flanges 25 carried by cylinder 14. After the cylinder 14 is secured to the shaft 12 and/or cylinder mounting surface 24, the plurality of targets 28 are machined into or through the cylinder 14. Preferably, the machining step is carried out be a single machining device in a single step to yield a plurality of targets 28 in a pattern 36. The machining allows for each target 28 of the plurality of targets 28 to move relative to each other. The machining also provides the precise distance 38 necessary between adjacent targets 28 for monitoring torque applied to shaft 12. When cylinder 14 is provided initially as a unitary cylinder 32, machining of targets 28 into cylinder 14 effectively splits cylinder 14 into two halves 32a and 32b. When cylinder 14 is provided initially as two components 32a, 32b, with or without rough targets 28, each component 32a, 32b will be secured to shaft 12. Subsequently, targets 28 will be finally machined in the same manner as described above.

In most cases a heat treating or any other material property modification will take place prior to the machining of targets. Thus, the machining of the plurality of targets 28 may occur at any point after the heat treating or material property change of shaft 12 and cylinder 14. Machining the plurality of targets 28 after heat treating shaft assembly 10 maximizes the precision of the machining and minimizes unwanted errors due to warping or residual motion of the shaft during the heat treating or material property change process. However, the heat treating and/or annealing may occur prior to cylinder 14 being secured to shaft 12. Additionally, the machining of the plurality of targets 28 may occur without or prior to heat treating the shaft 12 and cylinder 14.

In an alternative method, the steps of heat treating or material modification of shaft 12 and cylinder 14 may occur prior to bonding of the components together or after they are secured together, or heat-treating shaft 12 and cylinder 14 before or after the plurality of targets 28 are machined.

The step of mounting and securing cylinder 14 to shaft 12 will typically secure cylinder 14 to cylinder mounting surfaces 24. This step may take advantage of any known securement processes such as but not limited to welding, press fitting, riveting, and/or bonding. In some instances, the inner diameter 44 of cylinder 14 is the same as or is slightly smaller than the outer diameter 46 of cylinder mounting surface 24 of the shaft 12. This ensures that the cylinder 14 fits tightly on cylinder mounting surface 24. The primary goal of the bonding step being to provide distance 38 as a consistent distance around the resulting two cylinder halves, cylinder elements 32a, 32b, until torque is applied to shaft 12.

In the embodiments of FIGS. 2A, 3A and 4A, shaft 12 has a flexible area 30 that may have an outer diameter 48 that is less than the outer diameter 46. Flexible area 30 is positioned radially inward from the plurality of targets 28. Likewise, in embodiments of FIGS. 2B, 3B and 4B, shaft 12 has a flexible area located between inwardly projecting flanges 25 of cylinder 14. Further in the embodiments of FIGS. 2-4 shaft 12 has a diameter less than the diameter of cylinder 14 such that targets 28 are positioned radially outward from flexible area 30.

As discussed above, in the method of forming shaft assembly 10, cylinder 14 may be a unitary cylinder 32 which subsequently is separated by the machining process into two halves 32a and 32b. Alternatively, cylinder 14 may be provides initially as two separate elements identified in FIG. 11 as first cylinder element 32a and the second cylinder element 32b. In this configuration, the first and second cylinder elements 32a, 32b have the plurality of targets 28 partially pre-formed thereon. Following the steps of securing first and second cylinder elements 32a, 32b to cylinder mounting surfaces 24, the assembly may optionally be heat treated or otherwise subjected to material property modification. After this optional step, final machining of targets 28 will occur.

Similar to securing unitary cylinder 14 to cylinder mounting surfaces 24, securing separate cylinder elements 32a, 32b to cylinder mounting surfaces 24 may take advantage of any known securement processes such as but not limited to welding, press fitting, riveting, and/or bonding. In most configurations, common bonding methods will include welding or match drilling and riveting cylinder elements 32a, 32b cylinder mounting surface 24 with rivets 34. In most cases, following bonding of separate cylinder elements 32a, 32b to shaft 12, a heat treatment or material modification step will take place. Subsequently, final machining of targets 28 will then be carried out as described above. The primary goal of the described method being to provide and maintain distance 38 as a consistent distance around cylinder elements 32a, 32b until torque is applied to shaft 12.

As noted above, the step of machining the plurality of targets 28 into or through the cylinder 14 occurs after the cylinder 14 or cylinder elements 32a, 32b are secured to the shaft 12 and/or cylinder mounting surface(s) 24. Also, as previously noted, targets 28 may be partially preformed in cylinder 14 or cylinder elements 32a, 32b. When targets 28 have been partially preformed, final machining takes place after securing cylinder 14 or cylinder elements 32a, 32b to shaft 12 and/or cylinder mounting surface(s) 24. The machining step forms the plurality of targets 28 into the pattern 36. Pattern 36 may align the plurality of targets 28 in a uniformly parallel or uniformly slanted configuration. Alternatively, the resulting pattern may provide alternating slanted targets 28. In the configurations where, slanted targets 28 are used, targets 28 may or may not be parallel to one another. In yet another configuration, each target has its own a unique pattern relative to the closest targets on either side. The step of machining the plurality of targets 28 provides stress relief to the pattern 36 of the plurality of targets 28.

The shaft assembly 10 used in a torque measurement system which includes at least one sensor 46 provides the ability to derive axial information. The use of sensors and the derivation of axial information including torque values are known to those skilled in the art.

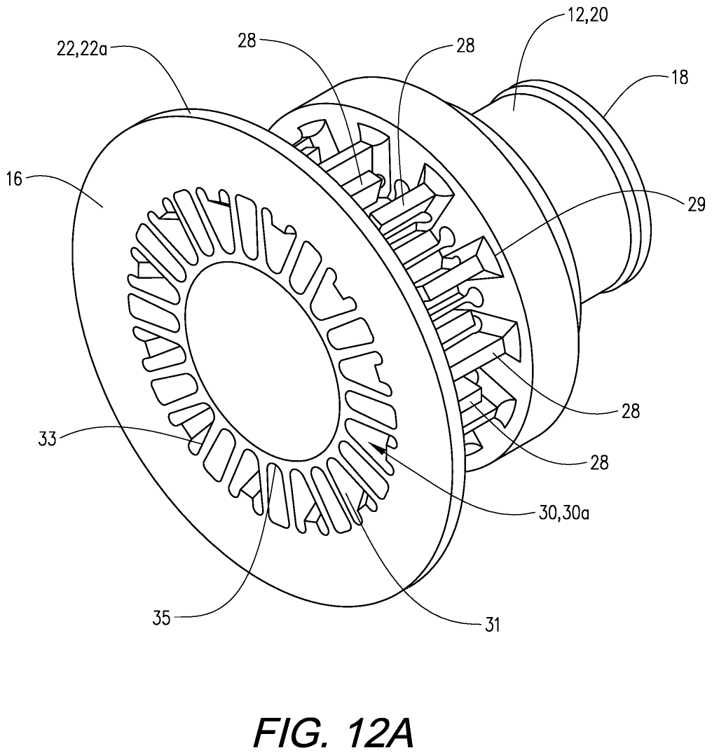

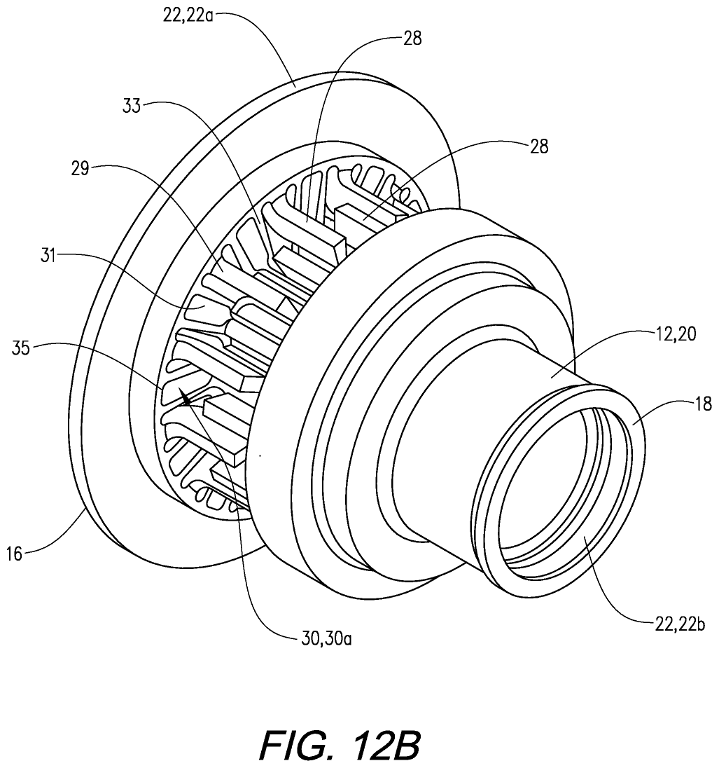

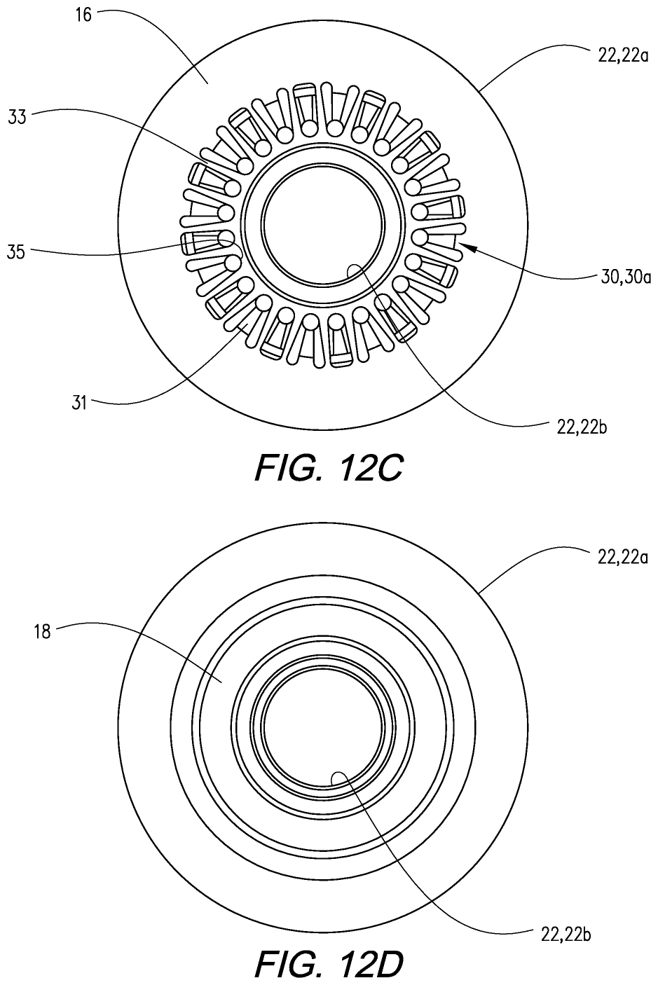

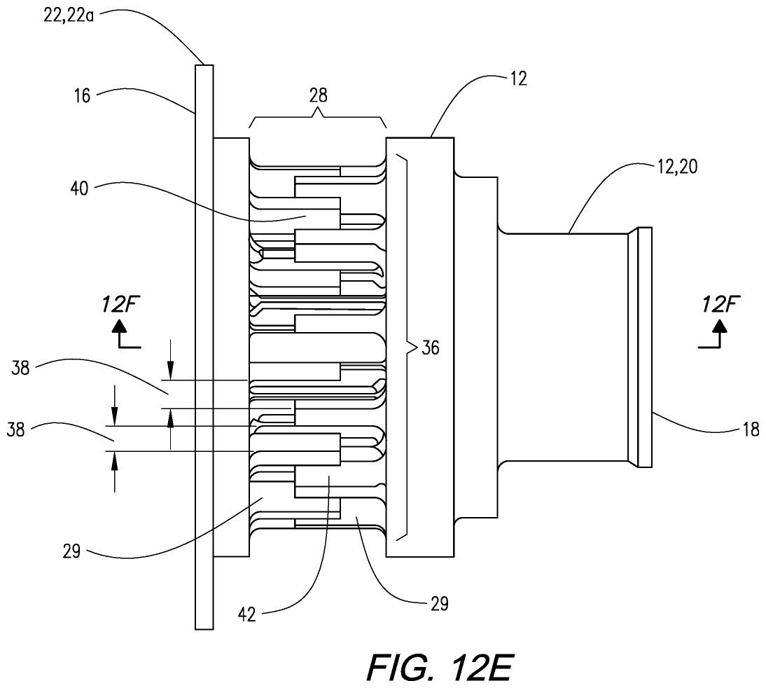

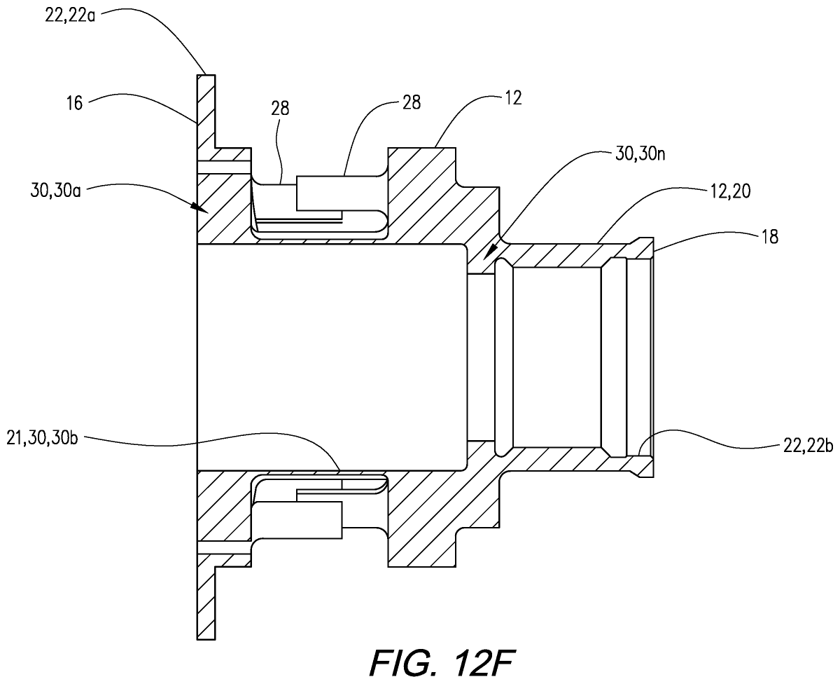

Referring to FIGS. 12A-12F, an alternate embodiment of shaft assembly 10 is illustrated. In this embodiment, shaft assembly 10 is prepared from a single integral element. Shaft assembly 10 may be machined from a single integral element, cast as a single form or three-dimensionally printed. In each instance, the result is a shaft assembly in the form of a single integral component. As used herein, a single integral component means that assembly of additional elements to shaft assembly 10 is not required. This embodiment eliminates the requirement for placing cylinder 14 over shaft 12 and securing cylinder 14 to shaft 12. Thus, shaft assembly 10 of FIGS. 12A-12F has only one component with equivalent structures providing shaft 12, flexible areas and targets 28. This embodiment eliminates potential failure modes between the shaft 12 and cylinder 14 of the previously discussed embodiments.

Using machining as a nonlimiting example of preparing shaft assembly 10, shaft assembly 10 is machined from a single piece of metal or other torque transmitting material. As illustrated, shaft assembly 10 includes the shaft 12 and the plurality of targets 28. Shaft 12 has first end 16 and second end 18. Shaft 12 also has outer surface 20, both of which are occasionally illustrated together as 12, 20 in FIGS. 12A-14C. Shaft 12 includes a first end 16 and a second end 18. Each end 16, 18 can be modified as necessary to permit attachment to a torque input device such as a transmission (not shown) while the other end will act as the torque output end of shaft 12. While machining is discussed, those skilled in the art will recognize that this embodiment may also be prepared by three dimensional printing and other conventional methods.

Referring to FIGS. 12A-12F, attachment element 22 may be used to connect the shaft assembly 10 between the torque input device and a subsequent component configured to be driven by shaft 12. The attachment element 22a may be positioned on the first end 16 and another attachment element 22b positioned on the second end 18. In the non-limiting illustrations of FIGS. 12A-12F, the attachment element 22a is an attachment flange 22a and attachment element 22b is capable of receiving an element that is transmitting torque. Attachment element 22 may also be a pair of attachment flanges 22 positioned on first and second ends 18, 20.

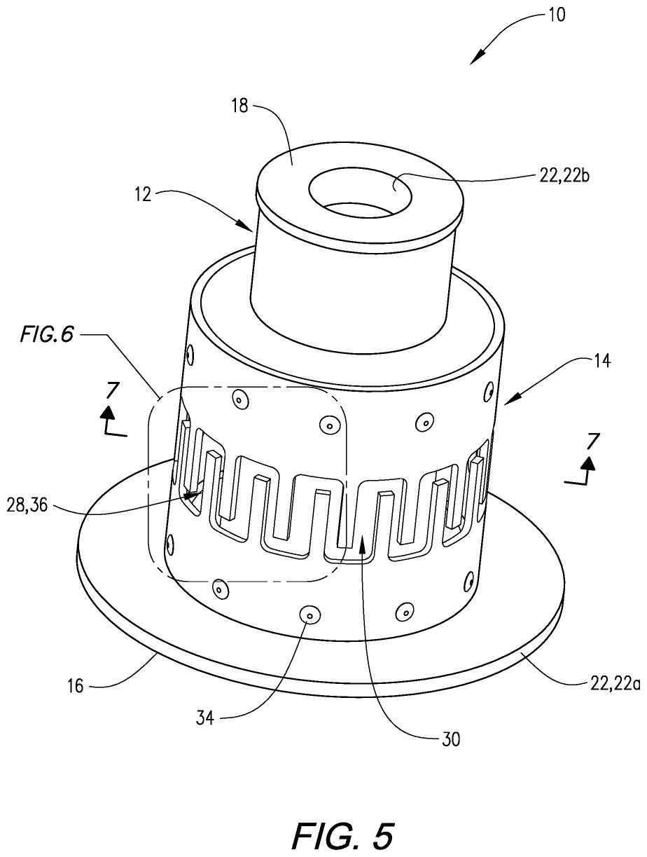

In the nonlimiting example of machining shaft assembly 10, the plurality of targets 28 are machined into a pattern 36. The plurality of targets 28 form a pattern 36 as part of shaft 12. The plurality of targets 28 and the corresponding pattern 36 for this embodiment are similar to the plurality of targets 28 and corresponding pattern 36 illustrated in FIGS. 5-10 except the plurality of targets are machined from a single shaft 12. FIG. 12E illustrates pattern 36. The pattern 36 of the plurality of targets 28 is still slanted, parallel, or a combination of slanted and parallel targets.

Referring to gap 38 illustrated in FIG. 12E, which corresponds to gap 38 found in FIGS. 5 and 6, each target of the plurality of targets 28 is separated from each other target by a gap 38. Each target has a first side 40 and a second side 42. Gap 38 is positioned between the first side 40 of a target and a second side 42 of an adjacent target 28. The plurality of targets 28 in this embodiment may be cantilevered from their base 29.

Due to the way the shaft assembly 10 is formed in the embodiment illustrated in FIGS. 12A-12F, this assembly has flexible area 30b and additional flexible area 30a. The machined passageways 31 illustrated in FIGS. 12A and 12B provide flexible area 30, 30a. As illustrated, machined passageways 31 have machined spokes 33 that are soft in torsion, low torsional stiffness, thereby permitting twisting at first end 16. Machined passageways 31 also have stress relief element 35. Machined passageways 31 and machined spokes 33 may be machined, formed, cast or three dimensionally printed, the descriptive names for generating passageways 31 and spokes 33 are not meant to be limiting. Flexible area 30, 30a is also illustrated in FIG. 12C. FIG. 12F depicts the location of flexible area 30, 30b. Flexible area 30, 30b corresponds in general terms to the flexible area provided by shaft 12 in the embodiment of FIGS. 1-11. In the embodiment of FIGS. 12A-F, wall 21 has been machined to a thin cross section. Thus, wall 21 of shaft 12 retained during the example machining process provides for the flexible area 30, 30b. Depending on the application of shaft assembly 10, wall 21 may have a thickness about 0.070 inch. The thickness of wall 21 will vary depending on the intended use of shaft assembly 10. The thickness can be determined based on the usage and degree of twist required. Application of torque to end 18 of shaft assembly 10 produces twist through flexible area 30, 30a and flexible area 30, 30b. As illustrated, flexible area 30, 30a and flexible area 30, 30b are in series and operate either cooperative with each other or independent of each other. The combination facilitates increased twist through shaft assembly 10 over having only one of either the flexible area 30, 30a or the flexible area 30, 30b. Additional flexible areas, generally illustrated as optional n^{th} flexible area 30, 30n, may be included in series with the flexible area 30, 30a and the flexible area 30, 30b. Also, it is possible to use only flexible area 30, 30a or flexible area 30, 30b for this embodiment. As noted above, a flexible area must reside in the path of torque transmission.

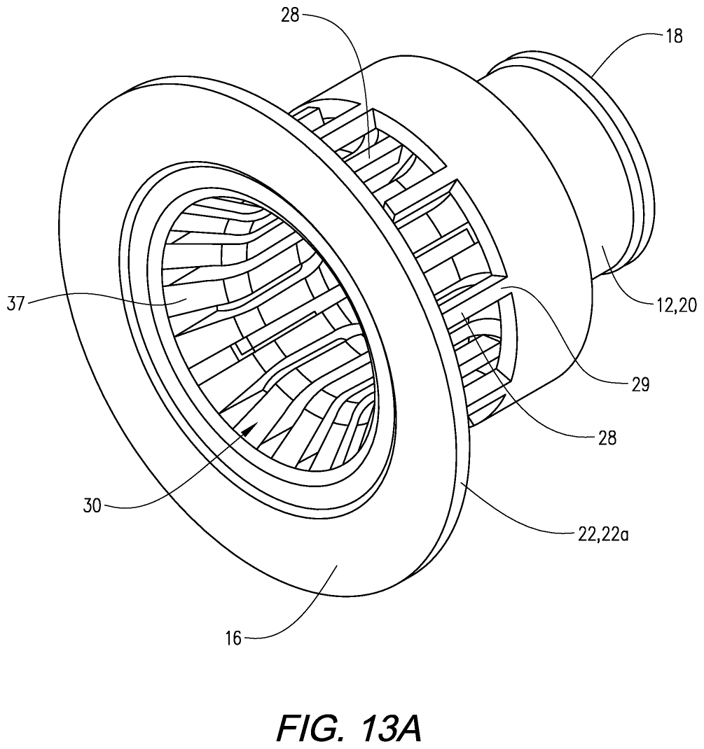

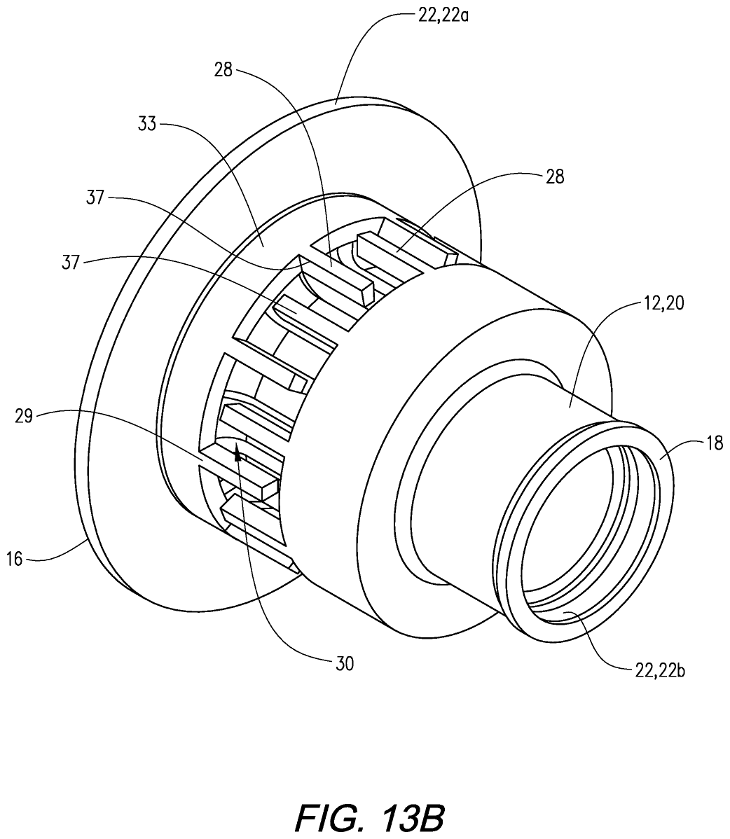

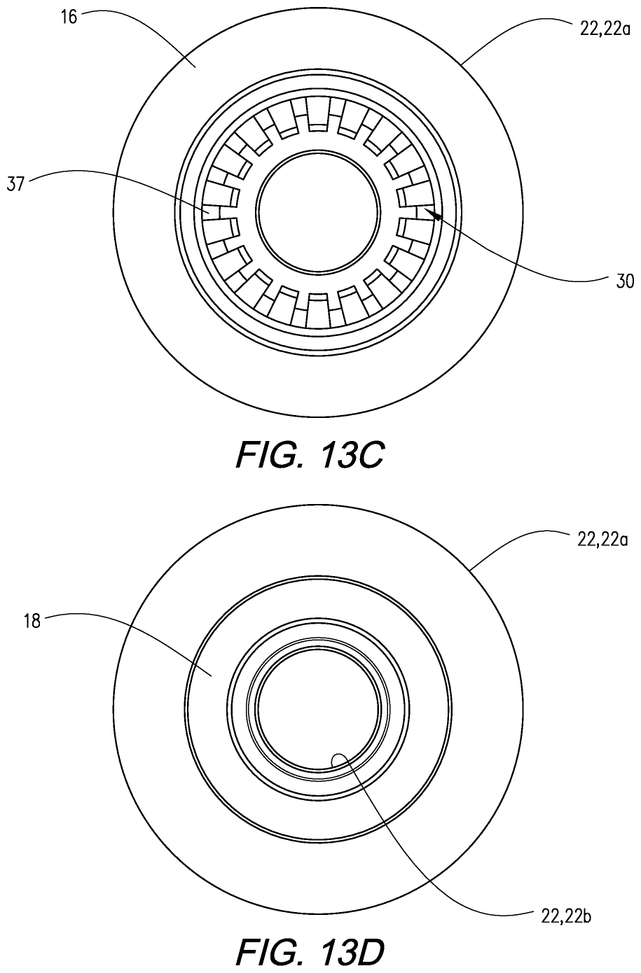

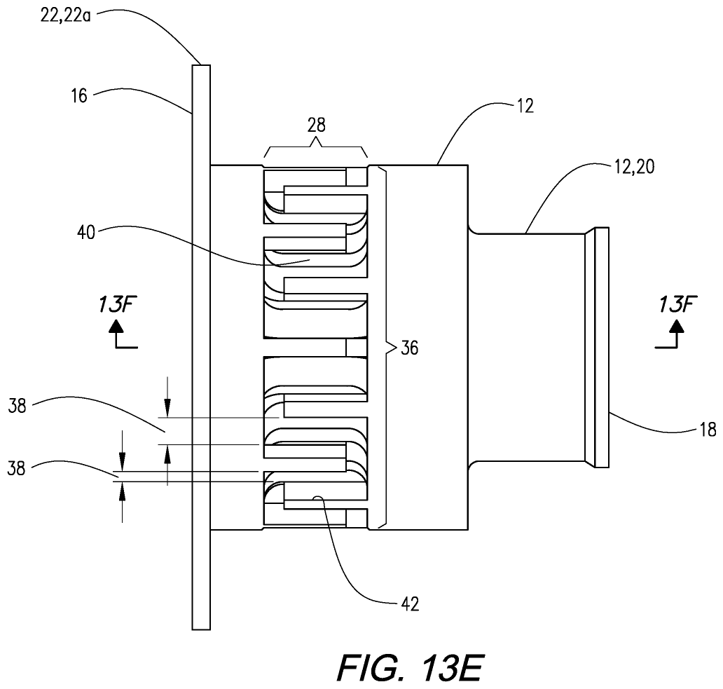

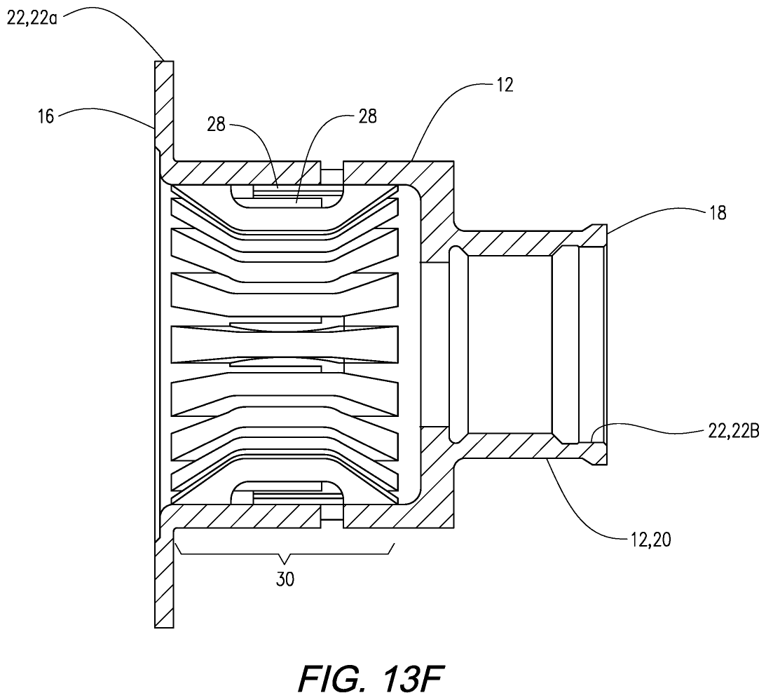

Referring to FIGS. 13A-13F, another alternate embodiment of shaft assembly 10 is illustrated that is similar to the embodiment illustrated in FIGS. 12A-12F where a single element is machined, formed or cast as shaft assembly 10. One difference in this embodiment from the embodiment illustrated in in FIGS. 12A-12F is the flexible area 30 where there is only one flexible area created by machined spokes 37. Otherwise, this embodiment also eliminates the requirement for placing cylinder 14 over shaft 12 and securing cylinder 14 to shaft 12 with fasteners such as rivets 34. Similar to the embodiment in FIGS. 12A-12F, preparing shaft assembly 10 from a single component reduces the number of pieces needed to create the shaft portion 12 and the target portions 28 of shaft assembly 10. In addition, this embodiment eliminates potential failure modes between the shaft 12 and cylinder 14.

Once again using machining as a nonlimiting example for preparing shaft assembly 10, shaft assembly 10 is machined from a single piece of metal or other torque transmitting material suitable for the intended use of shaft assembly 10. In this embodiment, shaft assembly 10 has a shorter length and/or width for use in smaller spaces. As illustrated, shaft assembly 10 includes the shaft 12 and the plurality of targets 28. Shaft 12 has first end 16 and second end 18. Shaft 12 also has outer surface 20, both of which are occasionally illustrated together as 12, 20 in FIGS. 12A-14C. The first end 16 and second end 18 are positioned between a first component (not shown) and a second component (not shown) of shaft 12. While machining is discussed, those skilled in the art will recognize that this embodiment may also be prepared by three dimensional printing and other conventional methods.

As described in the previous embodiments and referring to FIGS. 13A-13F, shaft 12 may further have an attachment element 22 used to connect the shaft assembly 10 between the first and second component, where one of the components is a torque input device (not shown) such as a transmission (not shown). The attachment element 22a may be positioned on the first end 16 and another attachment element 22b positioned on the second end 18. Or there may only be a single attachment element 22. In the non-limiting illustrations of FIGS. 13A-13F, the attachment element 22a is an attachment flange 22a and attachment element 22b is capable of receiving an element that is transmitting torque. Attachment element 22 may also be a pair of attachment flanges 22 positioned on first and second ends 18, 20. In general, for all embodiments, attachment elements 22 suitable for securing components to either end 18, 20 of shaft 12 are well known.

In the nonlimiting example of the step of machining shaft assembly 10, the plurality of targets 28 are machined into pattern 36. The plurality of targets 28 form pattern 36 as part of shaft 12. The plurality of targets 28 and corresponding pattern 36 for this embodiment are similar to the plurality of targets 28 and corresponding pattern 36 illustrated in FIGS. 5-10 except the plurality of targets are machined from a single component in connection with the machining of shaft 12. FIG. 13E illustrates pattern 36. Once again, the pattern 36 of the plurality of targets 28 may be slanted, parallel, or a combination of slanted and parallel targets.

Referring to gap 38 illustrated in FIG. 13E, which corresponds to gap 38 found in FIGS. 5 and 6, each target of the plurality of targets 28 is separated from each other target by a gap 38. Each target has a first side 40 and a second side 42. The gap 38 is positioned between the first side 40 of a target and a second side 42 of an adjacent target. The plurality of targets 28 in this embodiment may be cantilevered from their base 29.

Due to the way the shaft assembly 10 is formed in the embodiment illustrated in FIGS. 13A-13F, there is a single flexible area 30 having machined spokes 37. As illustrated, machined spokes 37 are soft in torsion, thereby allowing for increased twist through shaft assembly 10. Twist of shaft assembly 10 is focused through the flexible area 30. Machined spokes 37 may be machined, formed, cast, or three dimensionally printed, and the descriptive name is not meant to be limiting.

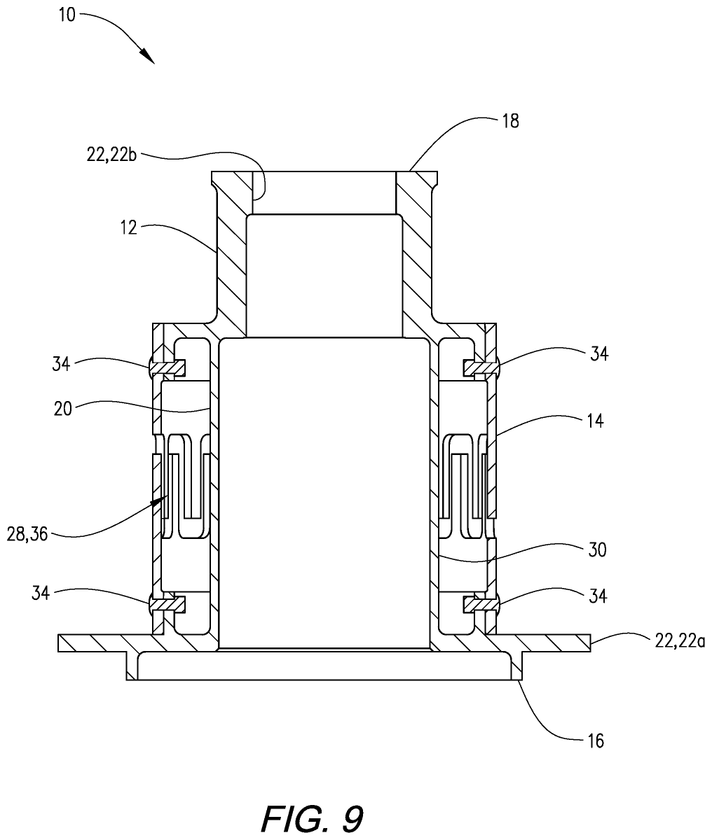

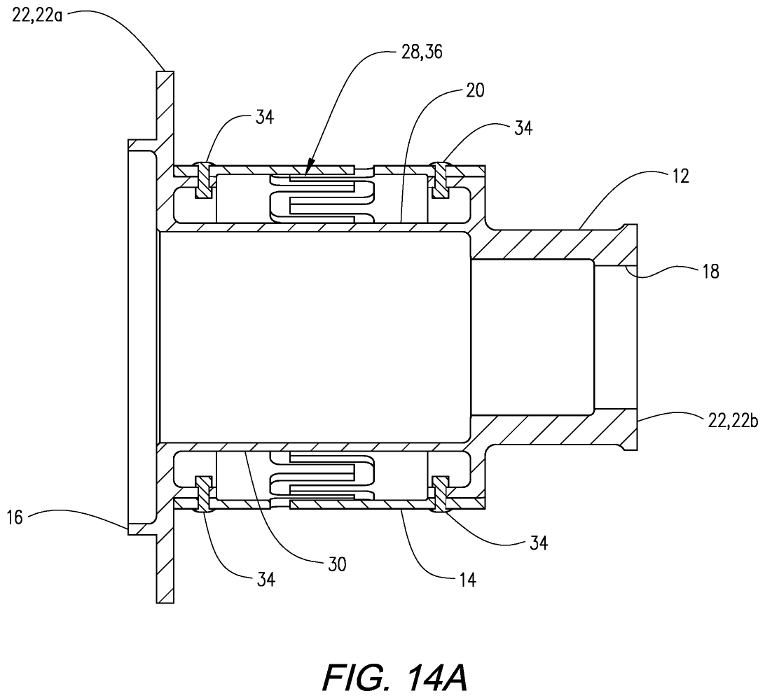

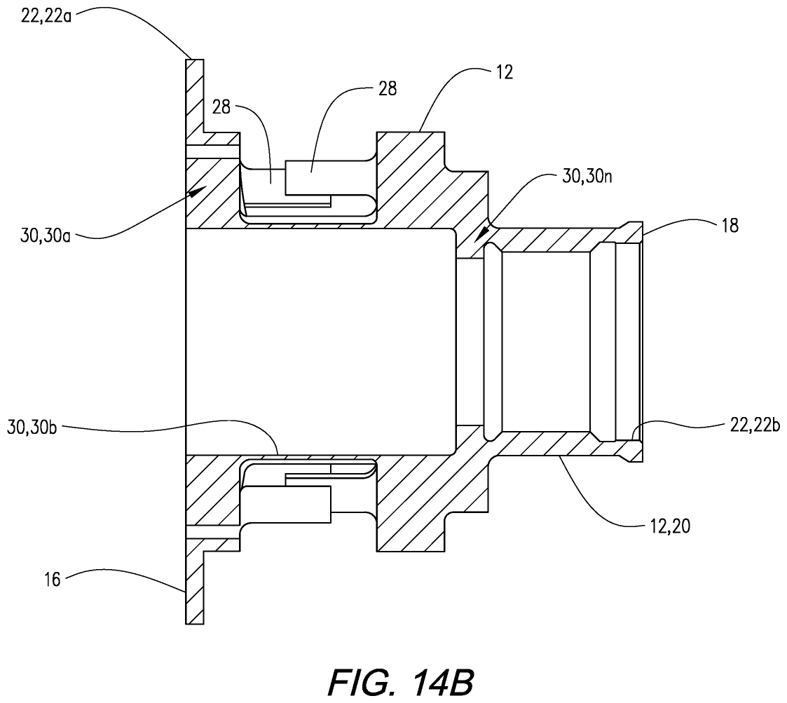

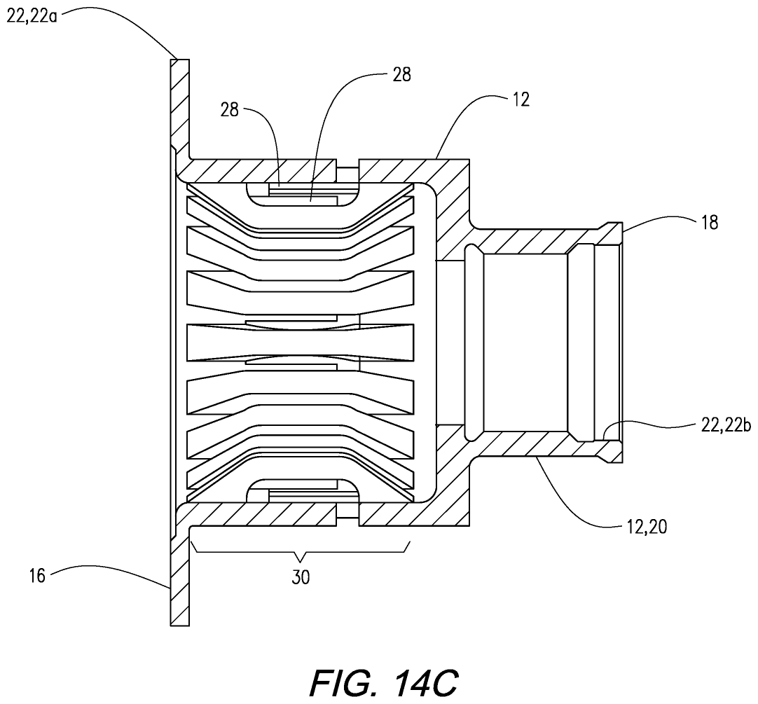

Referring to FIG. 14A, the embodiment illustrated in FIG. 9 is republished as FIG. 14A for comparison. In this embodiment, a cylinder 14 is positioned about shaft 12 with targets 28 formed thereon. The plurality of targets 28 may be formed after cylinder 14 is positioned about shaft 12, or the plurality of targets 28 may be formed prior to positioning cylinder 14 about shaft 12 followed by final machining of targets 28. The embodiment of FIG. 14A has a single flexible area 30. In comparison, FIGS. 14B and 14C illustrate the embodiments that are republish from FIGS. 12F and 13F, respectively. The embodiments in FIGS. 14B and 14C are machined, formed, cast, or three dimensionally printed from or as a single shaft 12. FIG. 14B illustrates two flexible areas 30, 30a, 30b of FIG. 12F, and FIG. 14C illustrates the single flexible area 30 of FIG. 13F.

In the embodiments illustrated in FIGS. 12A-13F, using a single initial material component to prepare shaft assembly 10 allows for improved manufacturing by lowering the overall costs to make shaft assembly 10, facilitating the use of less expensive materials and reducing scrap, and reducing the number of manufacturing steps. In addition, the manufacturing tolerances required for the embodiment illustrated in FIGS. 1-11 are less for the embodiments illustrated FIGS. 12A-13F. The elimination of a separate cylinder 14 that is secured to the shaft 12 by any of many known techniques means there is no ability for slippage or migration of the targets 28. Also, the elimination of securing techniques using fasteners such as rivets 34 means there are no fasteners that can fail from shear, stress, breakage, or becoming loose. Nor will there be the ability for the plurality of targets 28 to move as a fastener fails or for one side of the cylinder 14 and shaft 12 combination illustrated in FIGS. 1-11 to mover relative to the other side. In addition, there is no ability to create any damaging foreign objects as a fastener fails. Further, through the elimination of parts that must be welded or bonded together, the method also eliminates the need for additional certification or inspection.

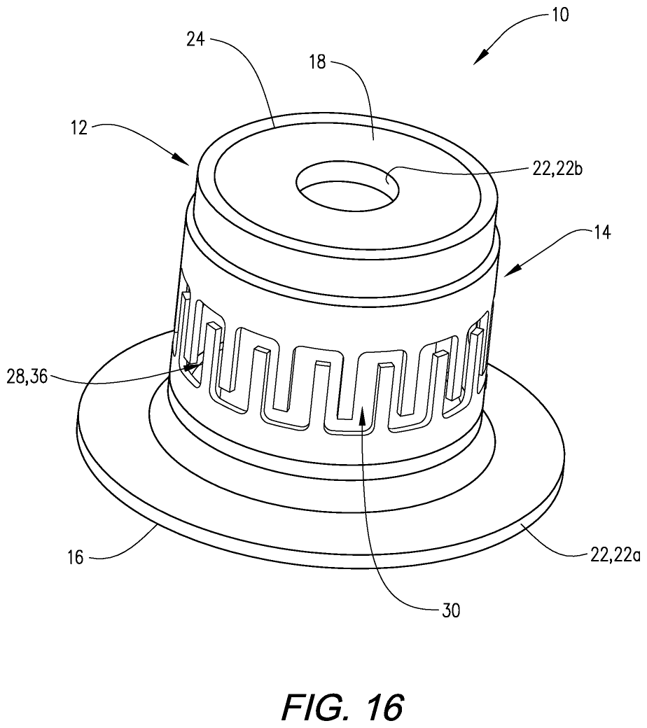

FIGS. 15 and 16 provide a further embodiment of shaft assembly 10. This embodiment corresponds generally to the embodiment of FIGS. 1-11; however, this embodiment does not rely upon rivets. Rather, the depicted embodiment provides an example of bonding, such as welding, of cylinder 14 to cylinder mounting surfaces 24. Further, to further enhance sensitivity to changes in torque, this embodiment provides at least one additional flexible zone 30c. Thus, the embodiment of FIGS. 15 and 16 includes two flexible zones 30 and 30c. However, either zone could be eliminated from this embodiment depending on the expected application of shaft assembly 10. In this embodiment, flexible zone 30c is located near first end 16. Flexible zone 30c is defined by a series of passageways or holes 31 passing through end 16. Each passageway 31 is separated by a spoke 33 from the next adjacent passageway 31. Removal of the material previously located in the areas of passageways 31 imparts flexibility thereby providing flex zone 30d.

The embodiment of FIGS. 15 and 16 is compatible with cylinder 14 as a unitary component or with cylinder 14 in the form of separate first and second cylinder elements 32a, 32b. In both versions, final targets 28 will be machined following securement of cylinder 14 or first and second cylinder elements 32a, 32b to cylinder mounting surfaces 24. When cylinder 14 is initially a single component, the machining step to provide targets 28 will separate the cylinder into two components—first and second cylinder elements 32a, 32b.

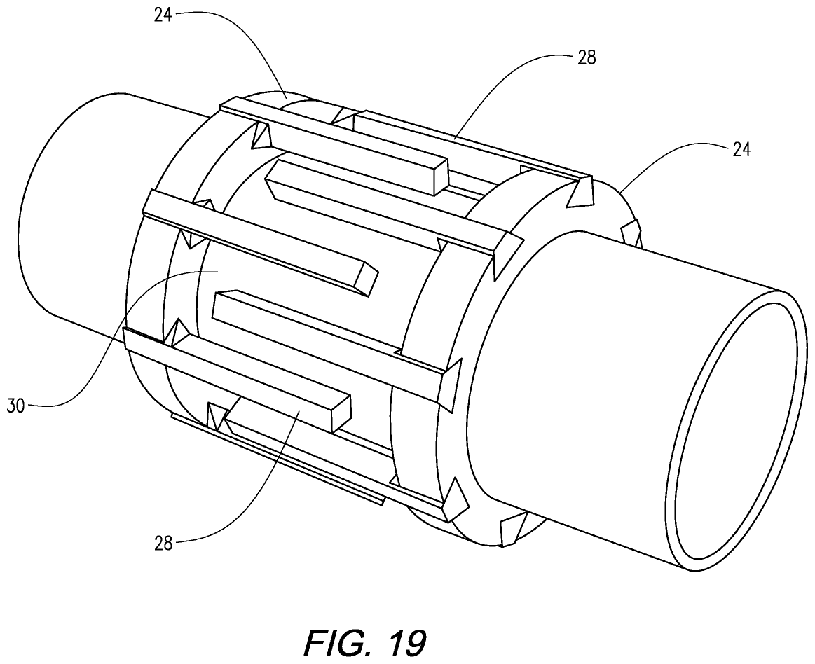

Additional exemplary embodiments are found in FIGS. 18 and 19. As depicted in FIG. 18, cylinder 14 has been replaced by targets 28 bonded directly to cylinder mounting surfaces 24. Following bonding of targets 28 to cylinder mounting surfaces 24, targets 28 will be machined to final tolerances as described above. As depicted in FIG. 19, targets 28 may be secured to cylinder mounting surfaces 24 by press fitting in a tongue and groove configuration. Following placement of targets 28 on cylinder mounting surfaces 24, targets 28 will be machined to final tolerances as described above.

The present subject matter can be embodied in other forms without departure from the spirit and essential characteristics thereof. The embodiments described therefore are to be considered in all respects as illustrative and not restrictive. Although the present subject matter has been described in terms of certain preferred embodiments, other embodiments that are apparent to those of ordinary skill in the art are also within the scope of the present subject matter.

1. A shaft assembly comprising:
a shaft having a first end, a second end, a first cylinder mounting surface, a second cylinder mounting surface and a first flexible area located between said first cylinder mounting surface and said second cylinder mounting surface;
a first cylinder element having a first end and a second end, wherein said first end of said first cylinder is secured to said first cylinder mounting surface and said second end of said first cylinder carries a first plurality of targets;
a second cylinder element having a first end and a second end, wherein said first end of said second cylinder is secured to said second cylinder mounting surface and said second end of said second cylinder carries a second plurality of targets;
wherein said first plurality of targets carried by said second end of said first cylinder and said second plurality of targets carried by said second end of said second cylinder form a pattern wherein the distance between adjacent targets defines a gap between adjacent targets;
wherein the first flexible area has a first outer diameter;
wherein the first cylinder mounting surface and the second cylinder mounting surface have a second outer diameter;
wherein the first cylinder element has an interior diameter equal to the second outer diameter; and
wherein said first outer diameter is less than said second outer diameter.

2. The shaft assembly of claim 1, wherein the first cylinder mounting surface is a first outwardly extending flange and the second cylinder mounting surface is a second outwardly extending flange and wherein the configuration of the shaft assembly permits movement of the first plurality of targets relative to the second plurality of targets, movement of the second plurality of targets relative to the first plurality of targets or movement of both said first and second plurality of targets relative to one another upon application of torque to either said first end or said second end.

3. (canceled)

4. (canceled)

5. (canceled)

6. The shaft assembly of claim 1, wherein said first end of said shaft includes a first component mounting point and said second end of said shaft includes a second component mounting point and further comprising at least a second flexible area located in at least one of said first and said second end, wherein said second flexible area defines a second region which will twist upon application of torque to either said first end or said second of said shaft.

7. The shaft assembly of claim 6, wherein said second flexible area comprises a series of openings passing through said first end or said second end with each opening separated by a spoke.

8. The shaft assembly of claim 1, wherein the gap between adjacent targets has a tolerance of about 0.0001 to about 0.0002.

9. (canceled)

10. (canceled)

11. The shaft assembly of claim 1, further comprising an outwardly projecting flange carried by said shaft, said outwardly projecting flange supporting either said first or second cylinder mounting surface and said outwardly projecting flange having a series of passageways therethrough, said passageways separated by spokes, said passageways and spokes defining a second flexible area.

12. An integral shaft assembly prepared from a single integral component comprising:
a first end, a second end, a flexible wall, said flexible wall located between said first end and said second end, wherein said flexible wall defines a first flexible area and said flexible wall has a first outside diameter and an inside diameter;
said first end carrying a first outwardly projecting flange having a second outside diameter greater than the first outside diameter of said flexible wall;
a second outwardly extending flange positioned either at said second end or between said second end and said first end, said outwardly extending flange having a second outside diameter;
a first plurality of targets carried by said first end, said plurality of targets projecting toward said second end and spaced apart from one another, said plurality of targets defining a circumference where said circumference has a diameter greater than said first outside diameter;
a second plurality of targets carried by said second end, said plurality of targets projecting toward said first end and spaced apart from one another, said plurality of targets defining a circumference where said circumference has a diameter greater than said first outside diameter;
wherein said second plurality of targets are positioned between said first plurality of targets and a gap exists between each adjacent target of said first plurality of targets and each adjacent target of said second plurality of targets;
wherein the configuration of said integral shaft assembly permits movement of said first plurality of targets relative to said second plurality of targets or movement of said second plurality of targets relative to said first plurality of targets or movement of both said first and second plurality of targets relative to one another upon application of torque to either said first end or said second end.

13. The integral shaft assembly of claim 12, wherein said first end of said shaft includes a first component mounting point and said second end of said shaft includes a second component mounting point and further comprising at least a second flexible area located in at least one of said first and said second end.

14. The integral shaft assembly of claim 12, further comprising a second flexible area located within said first end or said second end.

15. The integral shaft assembly of claim 12, wherein said first flexible area defines a first region which will twist upon application of torque to either said first end or said second end and said second flexible area defines a second region which will twist upon application of torque to either said first end or said second end.

16. (canceled)

17. The integral shaft assembly of claim 13, wherein said second flexible area comprises a series of openings passing through said first end or said second end with each opening separated by a spoke.

18. A method of preparing a shaft assembly for use in a torque measuring system where said torque measuring system includes a rotating shaft, the method comprising:
positioning a cylinder on the shaft and/or a cylinder mounting surface of the shaft, the shaft having a flexible area, the cylinder positioned radially outward from the flexible area;
securing the cylinder to the shaft and/or cylinder mounting surface; and
dividing the cylinder into a first cylinder element and a second cylinder element by machining a plurality of targets into or through the cylinder after the cylinder is secured to the shaft and/or cylinder mounting surface, wherein the first cylinder element has a first portion of the plurality of targets and wherein the second cylinder element has a second portion of the plurality of targets;
wherein upon application of torque to the shaft, the first portion of the plurality of targets are able to move relative to the second portion of the plurality of targets or the second portion of the plurality of targets are able to move relative to the first portion of the plurality of targets or the first portion and second portion of the pluralities of targets are both able to move; and,
wherein the step of machining the first portion of the plurality of targets and the step of machining the second portion of the plurality of targets defines a gap.

19. The method of claim 18, further comprising heat treating the shaft and cylinder after the shaft and cylinder are secured together.

20. The method of claim 19, wherein the machining the plurality of targets is performed at any point after the step of heat treating the flexible area and cylinder.

21. The method of claim 18, further comprising heat treating the shaft and cylinder before the shaft and cylinder are secured together.

22. The method of claim 21, further comprising machining the cylinder after heat treating the shaft and cylinder.

23. The method of claim 18, wherein the gap, defined by the step of machining the first portion of the plurality of targets and the step of machining the second portion of the plurality of targets, has a tolerance of about 0.0001 to about 0.0002.

24. The method of claim 18, wherein the machining is performed without heat treating the shaft and cylinder after the shaft and cylinder are secured together.

25. A method of preparing a shaft assembly for use in a torque measuring system where said torque measuring system includes a rotating shaft, the method comprising:
positioning a first cylinder element on the shaft and/or a first cylinder mounting surface of the shaft, the shaft having a flexible area, the first cylinder element positioned radially outward from the flexible area;
positioning a second cylinder element on the shaft and/or a second cylinder mounting surface of the shaft, the shaft having a flexible area, the second cylinder element positioned radially outward from the flexible area;
securing the first cylinder element to the shaft and/or the first cylinder mounting surface;
securing the second cylinder element to the shaft and/or the second cylinder mounting surface;
providing a pattern of targets by machining a first plurality of targets into or through the first cylinder element after the first cylinder element is secured to the shaft and/or cylinder mounting surface, the first plurality of targets having a pattern of targets and machining a second plurality of targets into or through the second cylinder element after the second cylinder element is secured to the shaft and/or cylinder mounting surface, the second plurality of targets having a pattern of targets; and,
wherein upon application of torque to the shaft, the first plurality of targets are able to move relative to the second plurality of targets or the second plurality are able to move relative to the first plurality of targets or the first and second pluralities of targets are both able to move; and,
wherein the step of machining the first plurality of targets on the first cylinder element and the second plurality of targets on the second cylinder element defines a gap.

26. The method of claim 25, further comprising heat treating the shaft and cylinder after the shaft and cylinder are secured together.

27. The method of claim 26, wherein the machining the plurality of targets is performed at any point after the step of heat treating the flexible area and cylinder.

28. The method of claim 25, further comprising heat treating the shaft and cylinder before the shaft and cylinder are secured together.

29. The method of claim 28, further comprising machining the cylinder after heat treating the shaft and cylinder.

30. The method of claim 25, wherein the gap, defined by the step of machining the first portion of the plurality of targets on the first cylinder element and the step of machining the second portion of the plurality of targets on the second cylinder element, has a tolerance of about 0.0001 to about 0.0002.

31. The method of claim 25, wherein the machining is performed without heat treating the shaft and cylinder after the shaft and cylinder are secured together.

32. A shaft assembly comprising:
a shaft having a first end, a second end, and a first outer diameter;
a first cylinder element having a first end and a second end, wherein said first end of said first cylinder carries a first inwardly projecting flange, said inwardly projecting flange defining a first inner diameter, where said first inner diameter corresponds to said first outer diameter, said inwardly projecting flange secured to said shaft;
a second cylinder element having a first end and a second end, wherein said first end of said second cylinder carries a second inwardly projecting flange, said inwardly projecting flange defining a first inner diameter, where said first inner diameter corresponds to said first outer diameter, said inwardly projecting flange secured to said shaft;
a first flexible area located between said first inwardly projecting flange of said first cylinder element and said second inwardly projecting flange of said second cylinder element;
a plurality of targets carried by said second end of said first cylinder element;
a plurality of targets carried by said second end of said second cylinder element;
wherein said plurality of targets carried by said second end of said first cylinder and said plurality of targets carried by said second end of said second cylinder form a pattern wherein the distance between adjacent targets defines a gap and said gap is consistent around a circumference of said shaft.

33. The shaft assembly of claim 32, wherein said first flexible area defines a region which will twist upon application of torque to either said first end or said second end of said shaft.

34. (canceled)

35. The shaft assembly of claim 33, wherein the first flexible area is configured to twist upon application of an external torque to either said first end or said second end of said shaft and the degree of twist is sufficient to shift said plurality of targets carried by said first cylinder element relative to said plurality of targets carried by said second cylinder element or to shift said plurality of targets carried by said second cylinder element relative to said plurality of targets carried by said first cylinder element.

36. (canceled)

37. The shaft assembly of claim 32, wherein said first end of said shaft includes a first component mounting point and said second end of said shaft includes a second component mounting point and further comprising at least a second flexible area located in at least one of said first and said second end, wherein said second flexible area defines a second region which will twist upon application of torque to either said first end or said second end of said shaft.

38. The shaft assembly of claim 37, wherein said second flexible area comprises a series of openings passing through said first end or said second end with each opening separated by a spoke.

39. The shaft assembly of claim 32, wherein the gap between adjacent targets has a tolerance of about 0.0001 to about 0.00015-0.0002.

40. (canceled)

41. (canceled)

42. A shaft assembly comprising:
a shaft having a first end, a second end, a first cylinder mounting surface, a second cylinder mounting surface and a first flexible area located between said first cylinder mounting surface and said second cylinder mounting surface;
a first plurality of targets secured to said first cylinder mounting surface;
a second plurality of targets secured to said second cylinder mounting surface;
wherein said first plurality of targets and said second plurality of targets pattern wherein the distance between adjacent targets defines a gap between adjacent targets and said gap is consistent around a circumference of said shaft.

43. The shaft assembly of claim 42, wherein the pattern further comprises the plurality of targets being uniformly parallel relative to each other.

44. The shaft assembly of claim 42, wherein the pattern further comprises the plurality of targets being uniformly slanted relative to each other.

45. The shaft assembly of claim 42, wherein the pattern further comprises the plurality of targets having a combination of parallel and slanted targets relative to each other.

46. The shaft assembly of claim 42, wherein the pattern further comprises the plurality of targets having a defined geometric shape allowing each target to move relative to each other.

47. The shaft assembly of claim 42, wherein the pattern further comprises each individual target of the plurality of targets having a unique orientation relative to at least each target nearest to each other.

48. The shaft assembly of claim 42, wherein the pattern further comprises the plurality of targets having alternating patterns.

49. The shaft assembly of claim 42, wherein said first flexible area defines a region which will twist upon application of torque to either said first end or said second end of said shaft.

50. The shaft assembly of claim 42, wherein the first flexible area is configured to twist upon application of an external torque to either said first end or said second end of said shaft and the degree of twist is sufficient to shift said plurality of targets carried by said first cylinder element relative to said plurality of targets carried by said second cylinder element or to shift said plurality of targets carried by said second cylinder element relative to said plurality of targets carried by said first cylinder element.

51. The shaft assembly of claim 50, where said first flexible area is configured to impart a shift between adjacent targets upon application of torque to either the first end or the second end.

52. The shaft assembly of claim 42, wherein said first end of said shaft includes a first component mounting point and said second end of said shaft includes a second component mounting point and further comprising at least a second flexible area located in at least one of said first and said second end, wherein said second flexible area defines a second region which will twist upon application of torque to either said first end or said second end of said shaft.

53. The shaft assembly of claim 42, wherein wherein the gap between adjacent targets has a tolerance of about 0.0001 to about 0.0002.

54. A method of preparing a shaft assembly for use in a torque measuring system where said torque measuring system includes a rotating shaft, the method comprising:
positioning a first cylinder element on the shaft and/or a first cylinder mounting surface of the shaft, the shaft having a flexible area, the first cylinder element positioned radially outward from the flexible area and the first cylinder element having a first plurality of rough pre-formed targets;
positioning a second cylinder element on the shaft and/or a second cylinder mounting surface of the shaft, the shaft having a flexible area, the second cylinder element positioned radially outward from the flexible area and the second cylinder element having a second plurality of rough pre-formed targets;
securing the first cylinder element to the shaft and/or the first cylinder mounting surface;
securing the second cylinder element to the shaft and/or the second cylinder mounting surface;
after the first cylinder element is secured to the shaft and/or cylinder mounting surface and after the second cylinder element is secured to the shaft and/or cylinder mounting surface, performing a final machining of the first plurality of rough pre-formed targets and the second plurality of rough preformed targets to provide a pattern of final targets; and,
wherein upon application of torque to the shaft, the first plurality of targets are able to move relative to the second plurality of targets or the second plurality are able to move relative to the first plurality of targets or the first and second pluralities of targets are both able to move.

55. The method of claim 54, further comprising heat treating the shaft and cylinder after the shaft and cylinder are secured together.

56. The method of claim 55, wherein the final machining step is performed after the step of heat treating the flexible area and cylinder.
